(19) United States
(12) Patent Application Publication
(10) Pub. No.: US 2026/0086038 A1
(43) Pub. Date: Mar. 26, 2026

(54) AUTONOMOUS MEASUREMENT SYSTEM FOR PERFORMING CONCENTRATION MEASUREMENTS IN A FLUID STREAM

(71) Applicant: FLUID PHOTONICS CORPORATION, Plainview, NY (US)

(72) Inventor: Dean G Gouramanis, Lindenhurst, NY (US)

(73) Assignee: FLUID PHOTONICS CORPORATION, Plainview, NY (US)

(21) Appl. No.: 19/112,249

(22) PCT Filed: Sep. 17, 2023
(86) PCT No.: PCT/US2023/074423

§ 371 Date: Mar. 16, 2025

Related U.S. Application Data
(63) Continuation-in-part of application No. 18/340,967, filed on Jun. 26, 2023.
(60) Provisional application No. 63/407,657, filed on Sep. 17, 2022.
(60) Provisional application No. 63/472,817, filed on Jun. 13, 2023.

(51) Int. Cl. G01N 21/85; G01N 21/77

(52) U.S. Cl. CPC G01N 21/85; G01N 21/77

(57) ABSTRACT

In an embodiment, a fluid concentration measurement system is disclosed. The measurement system comprises a sensor device comprising a sampling and measurement unit that is configured for insertion into a fluid stream. The sampling and measurement unit is configured to obtain a fluid sample from the fluid stream and to mix a reagent with the fluid sample to form a mixed sample. The sensor device further comprises a light source that is configured to illuminate the mixed sample and an optical sensor. The optical sensor is configured to receive light from the mixed sample based at least in part on the illumination of the mixed sample and generate sensor data based on the received light. The measurement system further comprises at least one processor that is configured to obtain the sensor data and determine a concentration of a target analyte in the fluid stream based on the sensor data.

### CROSS REFERENCE TO RELATED APPLICATION

This application is a continuation-in-part of U.S. patent application Ser. No. 18/340,967, filed on Jun. 2, 2023, and entitled “AUTONOMOUS MEASUREMENT SYSTEM FOR PERFORMING CHEMICAL CONCENTRATION MEASUREMENTS IN AN INDUSTRIAL PROCESS STREAM,” the entirety of which is incorporated by reference herein in its entirety.

This application claims the benefit of U.S. Provisional Ser. No. 63/472,817 , filed on Jun. 13, 2023, and entitled “CONFIGURABLE OPTICAL SENSOR FOR CONCENTRATION MEASUREMENT OF VARIOUS CHEMICAL COMPOUNDS IN FLUID” the entirety of which is incorporated by reference herein in its entirety.

This application claims the benefit of U.S. Provisional Ser. No. 63/407,657 , filed on Sep. 17, 2022, and entitled “INTEGRATED DEVICE FOR CONTINUOUS MONITORING OF PROCESS STREAM USING LUMINOUS FLUID SENSING ELEMENTS” the entirety of which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This application relates to performing concentration measurements in a fluid or fluid stream, and in particular, to a system and process for autonomously performing concentration measurements of target elements in a fluid or fluid stream.

Fluids and fluid streams often comprise more than just a particular fluid such as water. Instead, depending on the particulars of the fluid or fluid stream, various other elements or materials may either be suspended or dissolved in the fluid.

One example of a fluid or fluid stream is an industrial process stream, such as those comprising fluids flowing within pipes and tanks in an industrial processing center. Such fluid streams may be pressurized, corrosive, hazardous, extremely hot, extremely cold, located in hard-to-reach areas or have other attributes that may make it difficult to obtain measurements directly from the fluid. Typically, a sample of the fluid in an industrial process stream must be manually extracted from the industrial process stream and taken to another location for measurement testing, e.g., in a local laboratory on-site or in a remote laboratory. Such a manual process for measurement testing of an industrial process stream may be dangerous to the individual taking the sample, e.g., due to the potentially hazardous nature of the industrial process stream. In addition, such a manual process may lose accuracy relative to the target element concentrations actually found in the industrial process stream due to the delay involved in taking the sample, the delay in relocating the sample to the laboratory, the delay in testing the sample at the laboratory, the opportunity for contamination of the sample and a change in environmental variables relative to those existing in-situ at the industrial process stream.

In chemical engineering the need for chemical analysis of a sample is fundamental. From lab-scale research, to large-scale continuous manufacturing facilities, the knowledge of the exact chemical composition of a mixture at any given time may be of central important to controlling the process and parameters of the facility. However, peering into the world of molecular interactions often requires sophisticated and expensive instrumentation.

State-of-the-art technologies for determining elemental concentrations in material samples are typically based on inductively-coupled plasma (ICP) instrumentation. ICP analyzers heat material samples to thousands of degrees centigrade in order to induce energy emission which is analyzed by a spectrometer in order to deduce elemental concentration. While ICP analysis provides accurate elemental concentration measurements, the technology presents inherent limitations. For example, liquid samples must first be filtered and dehydrated in order to produce solids for ICP analysis and the sample preparation is a lengthy process, which generally requires manual labor, lab equipment and consumable supplies. Producing a measurement typically requires at least 1 hour before data is available and often takes days or even weeks depending on the availability of ICP analysis equipment. ICP analytical methods also cannot produce detailed information about the concentration of molecules. Instead, the molecules are digested by the measurement process into their elemental building blocks.

For the analysis of molecular composition, the field of analytical chemistry may provide some answers. However, quantifying any specific molecule is a complex endeavor which may require designing an effective analytical procedure that considers the target analyte as well as the composition of the particular solution in which it is contained.

To this end, liquid-liquid analytical techniques have been developed that may be leveraged to help analyze molecular compositions. One example of such a liquid-liquid analytical technique utilizes chemical sensors. A chemical sensor comprises an engineered reagent that is configured to enhance the measurability of a target analyte. As an example, the reagent may be configured to selectively interact with a molecule of interest and conditionally produce a unique signal that can be measured. However, implementing and functionalizing the use of such a reagent in a fluid stream may be challenging.

### SUMMARY

In an embodiment, a fluid concentration measurement system is disclosed. The measurement system comprises a sensor device comprising a sampling and measurement unit that is configured for insertion into a fluid stream. The sampling and measurement unit is configured to obtain a fluid sample from the fluid stream and to mix a reagent with the fluid sample to form a mixed sample. The sensor device further comprises a light source that is configured to illuminate the mixed sample and an optical sensor. The optical sensor is configured to receive light from the mixed sample based at least in part on the illumination of the mixed sample and generate sensor data based on the received light. The measurement system further comprises at least one processor that is configured to obtain the sensor data and determine a concentration of a target analyte in the fluid stream based on the sensor data.

In an embodiment, the sampling and measurement unit comprises a chamber, the chamber being in fluid communication with the fluid stream via a sample flow channel when the sampling and measurement unit is inserted into the fluid stream to obtain the fluid sample.

In an embodiment, the chamber is in fluid communication with a reagent flow channel, the sampling and measurement unit being configured to dispense the reagent from the reagent flow channel into the chamber for mixing with the fluid sample.

In an embodiment, the chamber is in fluid communication with a fluid flow channel, the sampling and measurement unit being configured to dispense a purge fluid from the fluid flow channel into the chamber.

In an embodiment, the sampling and measurement unit is configured to obtain the fluid sample from the fluid stream by causing a reverse flow of the purge fluid in the fluid flow channel to draw to the fluid sample from the sample flow channel into the chamber.

In an embodiment, the sampling and measurement unit is configured to oscillate between a forward flow and a reverse flow of the purge fluid in the fluid flow channel to facilitate a mixing of the fluid sample with the reagent in the chamber.

In an embodiment, the sampling and measurement unit is configured to purge the mixed sample from the chamber into the sample flow channel by causing a forward flow of the purge fluid in the fluid flow channel.

In an embodiment, the light source is configured to illuminate the mixed sample as it is purged into the sample flow channel and the optical sensor is configured to receive light from the mixed sample in conjunction with the purging.

In an embodiment, the measurement system further comprising a control station, the control station comprising at least one metering pump in fluid communication with at least one of the reagent flow channel and the fluid flow channel, the at least one metering pump being configured to cause forward and reverse flows in the reagent flow channel and fluid flow channel.

In an embodiment, the sensor device is configured to generate the sensor data in real-time while the sampling and measurement unit is inserted into the fluid stream.

In an embodiment, the at least one processor is configured to determine a value of at least one attribute of the fluid stream, correct the sensor data for the determined value of the at least one attribute of the fluid stream and determine the concentration of the target analyte based on the corrected sensor data.

In an embodiment, the at least one processor being configured to correct the sensor data for the determined value of the at least one attribute of the fluid stream comprises the at least one processor being configured to access a look-up-table corresponding to the at least one attribute of the fluid stream and correct the sensor data based at least in part on the look-up-table, the determined value of the at least one attribute of the fluid stream and the sensor data.

In an embodiment, the at least one processor is configured to obtain an updated look-up-table corresponding to the at least one attribute and replace the look-up-table with the updated look-up-table.

In an embodiment, the sensor device comprises a filter, the filter being selected based at least in part on the target analyte and being disposed between the optical sensor and the mixed sample to filter the light received by the optical sensor from the mixed sample to a predetermined wavelength band.

In an embodiment, the target analyte comprises a metal ion and the reagent comprises at least one of a metal-organic-framework (MOF)-based reagent and a carbon nanomaterial-based reagent.

An integrated autonomous system is described, comprising a chemical reactor, photonic instruments, and electronic instrumentation collectively controlled by an embedded computer in order to perform an analytical procedure in which a sample from the process is stream is isolated then chemically altered in order to induce an optical response that is analyzed by optical instruments.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is a block diagram of a system according to an embodiment.

FIGS. 2 and 3 are perspective views of a sensor device and control station of the system of FIG. 1 according to an embodiment.

FIG. 4 is a perspective view of the sensor device of FIG. 1 according to an embodiment.

FIG. 5 is a perspective view of the sensor device of FIG. 4 with a cover plate removed according to an embodiment.

FIG. 6 is an exploded perspective view of the sensor device of FIG. 4 according to an embodiment.

FIGS. 7-11 are perspective views of circuitry and a light shroud of the sensor device of FIG. 4 according to an embodiment.

FIG. 12 is an exploded perspective view of a sampling and measurement unit of the sensor device of FIG. 4 according to an embodiment.

FIG. 13 is a perspective view of a sample mixing unit of the sampling and measurement unit of FIG. 12 according to an embodiment.

FIG. 14 is a cross-sectional view of the sampling and measurement unit of FIG. 12 according to an embodiment.

FIGS. 15-18 are cross-sectional views of the sampling and measurement unit of FIG. 12 illustrating an example sampling process according to an embodiment.

FIG. 19 is a cross-sectional view of the sensor device of FIG. 4 according to an embodiment.

FIG. 20 is a cut-away perspective view showing the sensor device of FIG. 4 installed in a pipe structure according to an embodiment.

FIGS. 21 and 22 are cut-away perspective views showing the sensor device of FIG. 4 installed on a tank wall according to an embodiment.

FIG. 23 is a flow diagram of an example sampling and measurement process using the system of FIG. 1 according to an embodiment.

FIG. 24 is a flow diagram of an example sampling and measurement process using a computational algorithm of the system of FIG. 1 according to an embodiment.

FIG. 25 is a flow diagram of an example calibration process using a calibration framework of the system of FIG. 1 according to an embodiment.

FIG. 26 is a diagram illustrating interactions between analyte and contaminant spectral peaks according to an embodiment.

### DETAILED DESCRIPTION OF THE INVENTION

Subject matter will now be described more fully hereinafter with reference to the accompanying drawings, which form a part hercof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized, and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

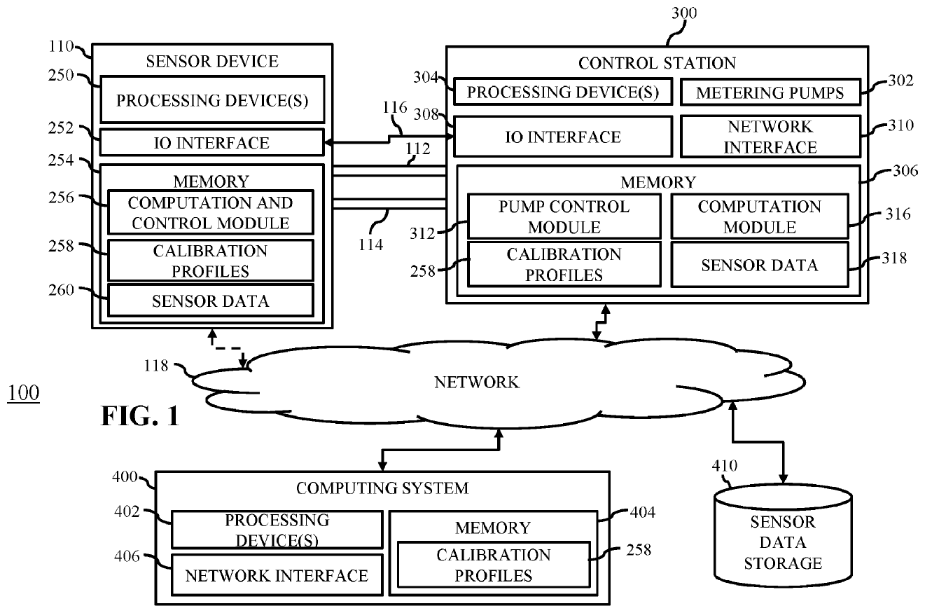

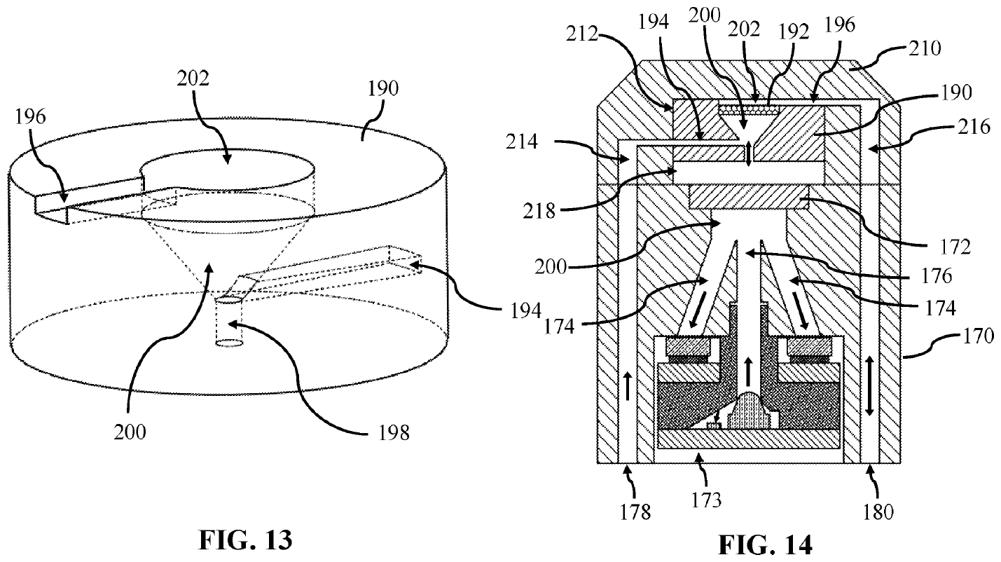

With reference to FIGS. 1-26, a system 100 is disclosed that implements a platform for autonomously performing concentration measurements in-situ in a fluid stream such as, e.g., an industrial process stream, wastewater stream, a river, sewage, a water supply, a standing pool, a fluid container or processing vessel or any other fluid flow or fluid containing system, all of which are individually and collectively referred to herein as a fluid stream. In some embodiments, a fluid stream as described herein may also or alternatively refer to a flow of fluid from a fluid source to system 100, e.g., by piping that receives fluid from the fluid source for use by system 100 or for any another purpose.

In an embodiment, system 100 is configured to utilize a reagent that interacts with a material, molecule or element of interest found in the fluid stream in order to induce a detectable change, e.g., a fluorescence, a change in absorption or any other detectable change. System 100 comprises integrated instrumentation that is packaged within a sensor device 110 that is deployable at least partially within the fluid stream or in fluid communication with the fluid stream and is configured to autonomously perform measurements of concentrations in-situ on the fluid stream.

Sensor device 110 comprises functionality that facilitates automated collection of measurement data directly from the fluid stream, enabling a more accurate, targeted and timely measurement of concentrations within the fluid stream while also reducing the exposure of individuals, such as workers at a processing facility, to the fluid stream during the manual sampling typically needed for an ICP analysis. Sensor device 110 is configured to leverage reagent based analytical techniques such as those described above in an automated package that is deployable at a variety of locations in-situ at the fluid stream to perform autonomous concentration measurements in real-time with little or no human supervision. In some use cases, for example, sensor device 110 may be located in harsh or remote environments that may not be easily accessible by a human on a regular basis. Sensor device 110 may be configured to provide measurement data electronically, e.g., in a wired or wireless manner, to a computer network, server, or any other computing device. Sensor device 110 may also be configured to receive commands or operating parameter adjustments electronically, e.g., in a wired or wireless manner, from the computer network, server, or any other computing device.

As used herein, the term “real-time” comprises a measurement that takes into account minor delays due to data storage, processing, networking or other similar minor delays, and also comprises near real-time measurements, e.g., within milliseconds, seconds or even minutes where the number of minutes is still substantially smaller than a period of time required for manually-operated systems that rely on ICP-S or other similar laboratory-based techniques for measurements.

Sensor device 110 is readily configurable to quantify various analytes by selecting and configuring corresponding sub-systems including, e.g., reagents, light sources, optics, filters, parameter calibration files and other components of sensor device 110. Sensor device 110 may, for example, be selectively configured with the sub-systems necessary for the detection of specific materials, molecules or elements and their concentrations within a particular fluid stream and environment.

In one example, sensor device 110 may be utilized to measure concentration levels of a rare earth element analyte in an industrial process stream, e.g., by using a corresponding reagent that is configured to interact with the rare earth element analyte of interest.

In another example, sensor device 110 may be utilized to measure phosphate levels in a lake that is contaminated by fertilizer runoff, e.g., by using a reagent comprising a solution containing genetically-modified bacteria. Fluorescent proteins have become a valuable tool in modern biomedical research where genetically modified cells may act as living sensors, producing fluorescent proteins in the presence of specific analytes.

In some embodiments, sensor device 110 is configured to utilize a reagent comprising a consumable liquid sensing material that provides improved performance over sensors utilizing solid chemical cells. For example, solid and stationary fluorescent sensing materials may degrade rapidly in corrosive, hot or pressurized fluid streams, or in outdoor locations exposed to environmental factors such as UV light and extreme temperatures and temperature changes. In addition, the accuracy of a sensing material may depend heavily on the freshness of the reagent, such as reagents containing living microbes, or a reagent containing proteins which denature at high temperatures. Sensor device 110 is configured to mix a controlled volume of a reagent, such as consumable liquid reagent, with the fluid stream, and perform the measurement process before significant degradation of the reagent occurs.

System 100 is also configured to provide ease of use and utility to research and engineering individuals that arc utilizing sensor device 110. For example, system 100 is configured to provide a user interface and integrated computation framework that may be utilized to update the calibration of sensor device 110. As an example, sensor device 110 may be calibrated using experimental characterization data such as that identified or generated in a laboratory setting, which may be uploaded to a computer program, which generates parameter calibration files that may be uploaded to the sensor device 110 via a wired or wireless connection. This functionality enables the research and engineering individuals or any other individual to rapidly functionalize analytical techniques for performing chemical concentration measurements that have been demonstrated in the laboratory in-situ at the fluid stream or fluid system of a relevant operating environment via sensor device 110. Sensor device 110 provides a scalable solution for advanced process monitoring at many locations in a chemical processing facility or any other fluid system.

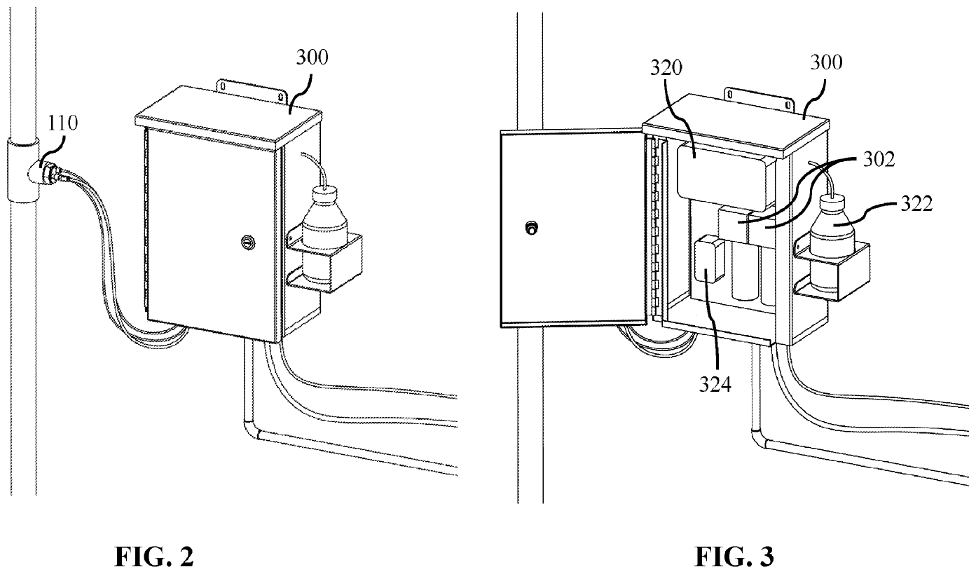

With reference to FIGS. 1 and 2, system 100 comprises a sensor device 110, a control station 300, a computing device 400, a sensor data storage 410, reagent tubing 112, fluid tubing 114, a data input/output connection 116 and a network 118. In some embodiments, each of reagent tubing 112, fluid flow tubing 114 and data input/output connection 116 may connect between sensor device 110 and control station 300 to provide a flow of fluids and data between control station 300 and sensor device 110. In other embodiments, one or more of tubing 112 and 114 and connection 116 may alternatively connect sensor device 110 to another location, device, or otherwise.

Reagent tubing 112 is configured for use by control station 300 to supply a reagent to sensor device 110. In some embodiments, for example, control station 300 may be configured to supply reagent to sensor device 110 at a predetermined rate, on-demand at a predetermined volume, or in another manner. As an example, in some embodiments, control station 300 comprises one or more metering pumps 302 that are actuatable to cause a predetermined or variable target amount of reagent to be supplied to sensor device 110 via reagent tubing 112 within a particular amount of time.

Fluid tubing 114 is configured for use by control station 300 or another device to supply a fluid to sensor device 110. In some embodiments, for example, control station 300 may be configured to supply fluids to sensor device 110 at a predetermined rate, on-demand at a predetermined volume, or in another manner. As an example, in some embodiments, control station 300 comprises one or more metering pumps 302 that are actuatable to cause a predetermined or variable target amount of fluid to be supplied via fluid tubing 114 to sensor device 110 within a particular amount of time. In some embodiments, for example, fluid tubing 114 may be utilized to supply water, a non-reactive liquid or any other liquid to sensor device 110, e.g., for flushing sensor device 110, diluting a sample being measured by sensor device 110, mixing the sample with the reagent or for any other reason. Other fluids may also or alternatively be supplied to sensor device 110 by fluid tubing 114 in other embodiments. As an example, in some embodiments, fluid tubing 114 may be utilized to supply a gas to sensor device 110, e.g., to facilitate mixing of a sample with the reagent supplied by reagent flow tubing 112, to facilitate a chemical reaction between the reagent and a target analyte or for any other reason.

Network 118 is configured to connect sensor device 110, control station 300, computing system 400 and sensor data storage 410 together comprises one or more wired, wireless or combined wired/wireless networks and corresponding hardware such as hubs, switches, access points, network interfaces or other hardware commonly found in a network. Example wired and wireless networks that may be utilized include the Internet, a wide area network (WAN), a local area network (LAN), satellite, telephone, cable, a fiber-optic, cellular, ethernet, WiFi, WiMAX, Bluetooth®, any other network or connection or any combination thereof.

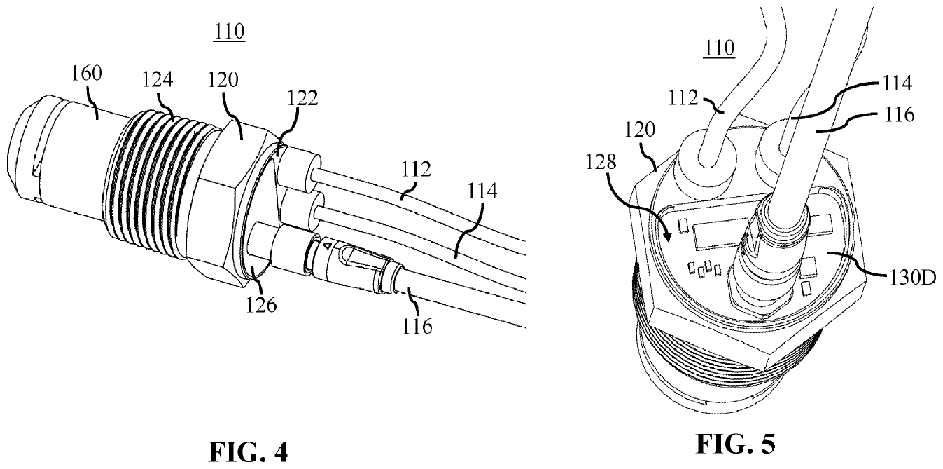

With reference again to FIGS. 4-19, sensor device 110 comprises a housing 120, circuitry 130A-130D, a light shroud 132, filters 152 and a sampling and measurement unit 160. Circuitry 130A-130D is also collectively and individually referred to herein as circuitry 130.

Housing 120 comprises a tubing and connection hub 122, a mounting mechanism 124, a cover plate 126, a circuit cavity 128 for receiving circuitry 130C and 130D, a cavity 129 for receiving sampling and measurement unit 160, a reagent flow channel 142 and a fluid flow channel 144.

Tubing and connection hub 122 is configured to fluidly couple reagent tubing 112 and fluid tubing 114 to sensor device 110 and to electrically couple data input/output connection 116 to sensor device 110. For example, tubing and connection hub 122 may be configured to fluidly couple reagent tubing 112 to reagent flow channel 142, fluidly couple fluid tubing 114 to fluid flow channel 144 and electrically couple data input/output connection 116 to a corresponding connection on circuitry 130D that extends through cover plate 126.

Mounting mechanism 124 comprises, for example, a pipe fitting or other similar component that is configured for easy and standardized installation on fluid systems such as, e.g., pipes, tanks, ducts or other components of a fluid control system through which a fluid stream flows. For example, mounting mechanism 124 may comprise a screw, a snap-fit, friction fit, clamp, compression fitting, gasket fitting or any other mounting mechanism. Mounting mechanism 124 or any other component of housing 120 may be fabricated or injection molded from a sturdy and corrosion resistant material such as stainless steel, nylon, polytetrafluoroethylene (PTFE) plastic or other corrosion resistant materials. In some embodiments, mounting mechanism 124 may be configured in accordance with NPT Pipe Plug fittings, Sanitary Quick-Connect fittings or Tri-Clamp sanitary fittings standards in order to facilitate integration with widely-used industrial equipment.

In some embodiments, sensor device 110 is configured for at least partial insertion into a mounting location 502 of a structure 500 of a target environment such as, e.g., a chemical processing facility, having a cavity 504 through which a fluid stream resides or flows. For example, as shown in FIGS. 20-22, structure 500 may comprise a pipe, tank wall, duct or other component having a cavity 504 through which the fluid stream flows or resides. Mounting mechanism 124 may be configured to mate with mounting location 502, such that mounting mechanism 124 and mounting location 502 together seal structure 500 against egress of fluid from the fluid stream with at least a portion of sampling and measurement unit 160 being exposed in fluid communication with the fluid stream.

With reference again to FIGS. 4-6, 10, 11 and 19, cover plate 126 is removable to access circuitry cavity 128 and circuitry 130C and 130D. In some embodiments, cover plate 126 comprises a through hole 127 that is configured to receive a connection terminal of circuitry 130D therethrough. In some embodiments, for example, circuitry 130C and 130D may be removed and replaced or otherwise accessed by removing or opening cover plate 126. In some embodiments, cover plate 126 may be removable in-situ for field repair or replacement of components of sensor device 110 without the need to decouple sensor device 110 from structure 500.

With reference to FIGS. 4, 6, and 7-19, sampling and measurement unit 160 comprises a sensor body 170, a window 172, circuitry cavity 173, a sample mixing unit 190, a porous member 192 and a cap 210. Sampling and measurement unit 160 is configured to receive an assembly of circuitry 130A and 130B, and light shroud 132 and filters 152 within circuitry cavity 173 such that the optical sensors 150 of circuitry 130A, filters 152 and the light source 146 of circuitry 130B are in optical communication with window 172. Sampling and measurement unit 160 is configured for insertion into cavity 129 of housing 120 such that sample mixing unit 190 and cap 210 extend out of housing 120, e.g., for insertion into the fluid stream. In some embodiments, a material such as a liquid, gas, epoxy or other material may be disposed within circuitry cavity 173 between sensor body 170 and circuitry 130A and 130B to provide protection or other properties. In some embodiments, a length of sensor body 170 may be selected for a particular use case. For example, sensor bodies 170 having various lengths may be available for integration into sensor device 110 to ensure that when installed in a target environment, sample mixing unit 190 and cap 210 extend into the fluid stream.

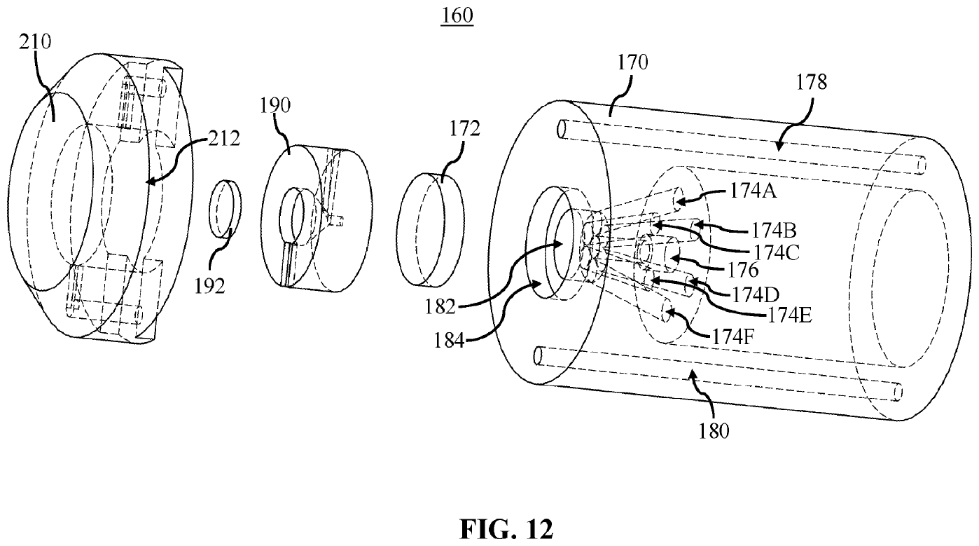

With reference to FIGS. 12, 14 and 19, sensor body 170 comprises light pathway channels 174A, 174B. 174F each of which is aligned with a corresponding one of optical sensors 150 and a light pathway channel 176 which is aligned with light source 146. Light pathway channels 174A, 174B. 174F are also individually and collectively referred to herein as light pathway channel(s) 174. While only six light pathway channels 174 and optical sensors 150 are illustrated and described herein, in other embodiments, a larger or smaller number of light pathway channels may alternatively be utilized, e.g., depending on the particular use case, target analyte, and target environment. Similarly, while only one light pathway channel 176 and light source 146 is illustrated and described herein, any other number of light pathway channels 176 and light sources 146 may alternatively be utilized. As an example, multiple light sources 146 may be present that emit light in different wavelengths along one or more light pathway channels 176. In some embodiments, multiple light sources 146 may utilize the same light pathway channel 176 or even emit light in the same wavelength along multiple pathway channels.

In some embodiments, one or more of light pathway channels 174 and 176 may comprise fiber optics or other light transmission mediums. In other embodiments, light pathway channels 174 and 176 may also or alternatively be formed from or coated with a reflective or absorbative material. For example, in some embodiments, an absorbative material that is configured to absorb the type of light being measured as part of the measurement process may be utilized where, for example only light that travels directly down a particular light pathway channel 174 may be received by the corresponding optical sensor 150. Such a configuration may, for example, enhance the quality of the measurement signal. In an embodiment where the amount of light that is being measured directly is insufficient to quantify effectively, a reflective coating or light transmissive medium may alternatively be utilized to enhance the quantity of light that is received at the corresponding optical sensor 150. Any other configuration or material for light pathway channels 174 or 176 may also or alternatively be utilized.

With continued reference to FIGS. 12, 14 and 19, sensor body 170 further comprises an inner cavity 182 and a window shelf 184. Window shelf 184 is configured to receive window 172 to seal inner cavity 182 and inhibit the inflow of fluids into inner cavity 182 via window shelf 184. In an embodiment, each light pathway channel 174 and 176 extends to inner cavity 182 such that a light path from light source 146 extends into inner cavity 182 via light pathway channel 176 and a light path from inner cavity 182 extends through each light pathway channel 174 to a corresponding optical sensor 150.

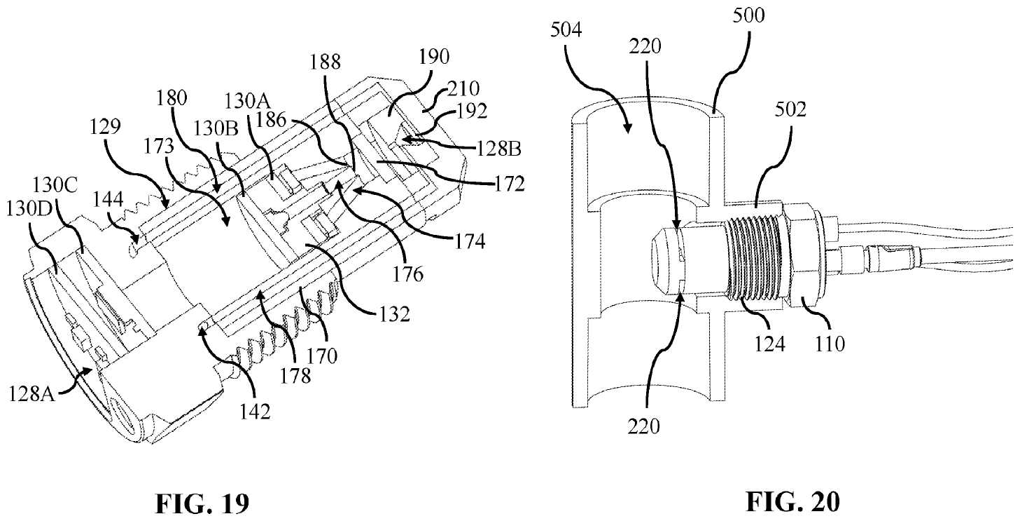

Lens components 186 (FIGS. 19) and 188 (FIG. 19) may be disposed at the interface between each light pathway channel 174 and 176 and inner cavity 182 in some embodiments (only one of each lens component is labeled for clarity). In some embodiments, window 172 may also or alternatively comprise a lens component. For example, in some embodiments, lensing may be performed by only one or more of lens components 186 and 188 with window 172 not performing any lensing. In other embodiments, only window 172 may perform lensing and lens components 186 and 188 may not be present (or not be configured to perform any lensing for their respective light pathway channels 174 or 176). In other embodiments, some or all of lens components 186 and 188 may perform lensing in addition to lensing performed by window 172. In yet other embodiments, none of lens components 186 and 188 and window 172 may perform lensing (in which case window 172 may simply be glass, quartz, sapphire, silicon or another material that is not configured as a lens and lens components 186 and 188 may not be present). Any other combination of lens components maybe alternatively be utilized.

Sensor body 170 is configured to optically expose light source 146 and optical sensors 150 to the fluid strcam via light pathway channels 174 and 176, inner cavity 182 and window 172. Window 172 is configured to allow light emitted by light source 146 and traveling through light pathway channel 176, lens component 188 and inner cavity 182 to enter a portion of the fluid stream that is temporarily captured by sample measurement unit 190. Window 172 is also configured to allow light from sample measurement unit 190 to return through inner cavity 182, lens components 186 and light pathway channels 174 to corresponding optical sensors 150. As an example, fluorescence or reflections caused by the light emitted by light source 146 may be received from the sample. In some embodiments, a reduction in light due to absorption may also be measured, e.g., by performing two or more measurements, performing pre-reagent dispensing and post reagent dispensing measurements, periodic measurements or in any other manner.

Window 172 may comprise an optically transparent window. As an example, window 172 may be formed of a material such as glass, quartz, sapphire, silicon or any other material that is transparent to the wavelength of light selected for emission by light source 146 toward sample measurement unit 190 or the wavelengths of light emitted/reflected from the fluid sample back toward light pathway channels 174 and the corresponding optical sensors 150. As mentioned above, in some embodiments, window 172 may also or alternatively be configured as a lens. The material used for window 172 may also be selected based on the environment and composition of the fluid stream where some fluid streams may be more corrosive or damaging to a particular material than others.

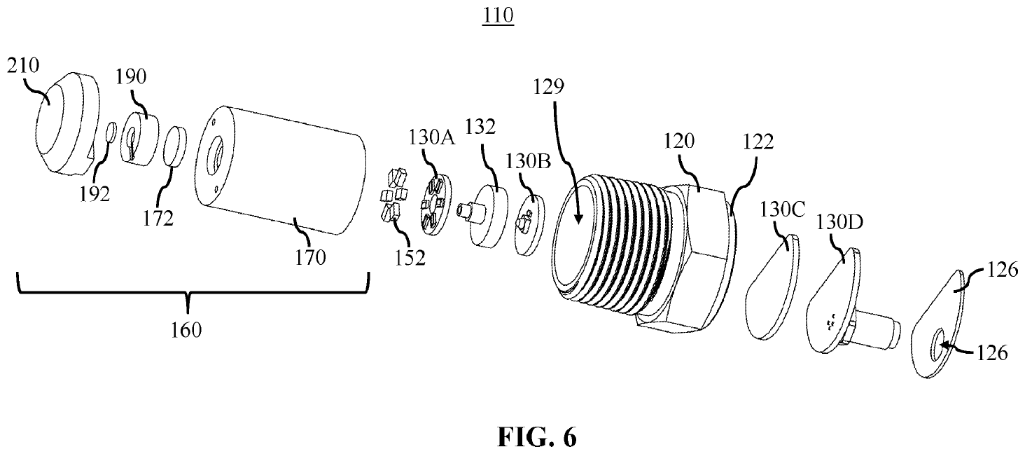

With reference to FIGS. 6, 7-9 and 19, light shroud 132 is disposed between circuitry 130A and circuitry 130B when assembled together and is configured to inhibit or shroud the direct exposure of optical sensors 150 to light generated by light source 146. For example, as shown in FIG. 19, when circuitry 130A, circuitry 130B and light shroud 132 are assembled together and inserted into circuitry cavity 173 of sensor body 170, a portion of light shroud 132 extends into light pathway channel 176 to inhibit light from bleeding back onto optical sensors 150. In some embodiments, a brightness detector 148 is located on circuitry 130B such that when circuitry 130B is assembled with light shroud 132, brightness detector 148 is exposed to light from light source 146 and able to measure the light output by light source 146. Such measurements by brightness detector 148 may be utilized, for example, to quantify the amount of like being generated and provided to the sample by light source 146, for calibration or for any other purpose. As an example, components of circuitry 130 (e.g., a DAC and MCU), light source 146 and brightness detector 136 may be configured as a closed-loop constant-brightness light source system that is configured to reduce or inhibit errors caused by temperature fluctuations or service life degradation of the electronic and optical components.

Light source 146 is configured to illuminate a fluid stream sample that has been mixed with a reagent to cause the fluid stream sample to fluoresce, reflect or absorb light in a manner that may be measured by sensor device 150. The brightness, wavelength, or both of light source 146 may be modulated by circuitry 130, for example, by DAC circuitry which is in communication with an MCU. In some embodiments, light source 146 comprises an electronically modulated precision light source, for example, one or more light emitting diodes (LEDs). As an example, light source 146 may comprise several LEDs which are multiplexed by a switching circuit of circuitry 130 to the DAC in some embodiments. Other types of light sources 146 may also or alternatively be utilized including, for example, lasers, xenon arc lamp, phosphor-based white light sources or incandescent lamps.

Light source 146 may be configured to emit in any electromagnetic wavelength including, e.g., visible light, radio, microwave, infrared, ultraviolet light, x-rays, gamma rays or any other wavelength of electromagnetic radiation. For example, in some embodiments, a type of light source 146 may be selected based on characteristics or parameters associated with a target analyte, reagent, environment, or any other characteristics or parameters.

Brightness detector 148 is positioned to monitor the output from light source 146 and in some embodiments is optically isolated from reflections or emissions of the fluid sample contained within sample measurement unit 190. For example, brightness detector 148 may be position such that when circuitry 130B is assembled with circuitry 130A and light shroud 132, brightness detector 148 is in optical communication with light source 146 but optically isolated from sample measurement unit 190 such that light emitted by light source 146 is measurable by brightness detector 148 while fluorescence or reflections from a fluid stream sample contained within sample measurement unit 190 are not received by brightness detector 148.

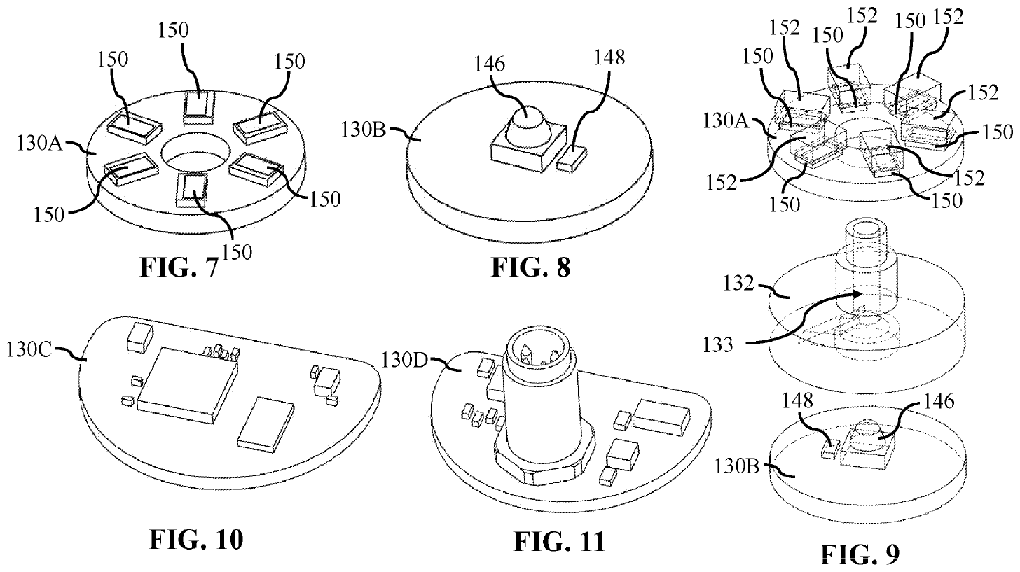

Optical sensors 150 are disposed on circuitry 130A and positioned such that they are exposed to light received via light pathway channels 174 from a fluid stream sample contained in sample measurement unit 190. Optical sensors 150 may comprise, for example, photodiodes or any other type of optical sensor. In some embodiments, optical sensors 150 may comprise six optical sensors, e.g., as shown in FIG. 7. In other embodiments, any other number of optical sensors 150 may be utilized. In some embodiments, optical sensors 150 may be arranged radially around light source 146. In other embodiments, optical sensors 150 may be arranged in any other manner relative to light source 146. Optical sensors may be configured to detect any electromagnetic wavelength including, e.g., visible light, radio, microwave, infrared, ultraviolet light, x-rays, gamma rays or any other wavelength of electromagnetic radiation. For example, in some embodiments, a type of each optical sensors 150 may be selected based on characteristics or parameters associated with a target analyte, reagent, environment, or any other characteristics or parameters.

Filters 152 may be assembled on optical sensors 150 as shown in FIG. 9 such that each filter 152 filters light received by a corresponding optical sensor 150 from a corresponding light pathway channels 174. As an example, filters 152 may be disposed on optical sensors 150, e.g., as a film or layer, as shown in FIG. 9. In some embodiments, filters 152 may have the same shape as optical sensors 150. In some embodiments, filters 152 may comprise band-pass filters which correspond with emission or reflectance peaks of a variety of chemical compounds. The bandpass filters may, for example, be cylindrical with the bandpass filter coating on one of the circular surfaces, an anti-reflective coating on the opposite circular surface, and a light absorbing coating, e.g., a black coating, around the cylindrical diameter. In some embodiments, the combination of an optical sensor 150 with a corresponding filter 152 may form a non-dispersive optical sensor.

Lens component 188 is configured to direct light beams from light source 146 via light pathway channel 176 toward sample measurement unit 190. In some embodiments, lens component 188 may comprise a collimating lens. In other embodiments, other types of lenses may also or alternatively be utilized.

Lens components 186 are configured to direct light beams from sample measurement unit 190 toward optical sensors 150 via light pathway channels 174. In some embodiments, for example, one or more of lens components 186 may comprise collimating lenses. In other embodiments, other types of lenses may also or alternatively be utilized.

Sensor body 170 also comprises a reagent flow channel 178 and a fluid flow channel 180 that are disposed in fluid communication with reagent tubing 112 via reagent flow channel 142 and fluid tubing 114 via fluid flow channel 144, respectively, when sampling and measurement unit 160 is installed in housing 120.

With reference to FIGS. 12-19, sample measurement unit 190 comprises a reagent flow channel 194, a fluid flow channel 196, a sample flow channel 198, a sample mixing chamber 200 and a fluid distribution chamber 202. Each of reagent flow channel 194, fluid flow channel 196, sample flow channel 198, sample mixing chamber 200 and fluid distribution chamber 202 are disposed in fluid communication with each other. Fluid distribution chamber 202 is configured to receive a porous member 192 between an inlet from fluid flow channel 196 and sample mixing chamber 200.

Cap 210 comprises a cavity 212 that is configured to receive sample measurement unit 190. Cap 210 also comprises a reagent flow channel 214, a fluid flow channel 216 and a sample flow channel 218.

Sampling and measurement unit 160 is assembled by attaching sensor body 170, sample measurement unit 190 and cap 210 together, for example, as shown in FIGS. 12-19. As shown in FIG. 14, reagent flow channel 214 is disposed between reagent flow channel 178 of sensor body 170 and reagent flow Reagent flow channel 194 of sample measurement unit 190 to provide fluid communication between reagent flow channels 178 and 194 for dispensing reagent into sample mixing chamber 200. Fluid flow channel 216 is disposed between fluid flow channel 180 of sensor body 170 and fluid flow Reagent flow channel 196 of sample measurement unit 190 to provide fluid communication between fluid flow channels 180 and 196 for dispensing fluids into sample mixing chamber 200 via fluid distribution chamber 202 and porous member 192.

As seen in FIG. 14, light from light pathway channel 176 is directed at sample flow channels 198 and 218, e.g., due to the angle of light pathway channel 176, lensing caused by the presence of a lens component 188, lensing caused by window 172, reflectance in light pathway channel 176 or any combination thereof. Similarly, light is received from sample flow channels 198 and 218 by light pathway channels 174, e.g., due to the angles of light pathway channels 174, lensing cause by the presence of lens components 186, lensing caused by window 172, reflectance of light pathway channels 174 or any combination thereof. In some embodiments, a focal region of light pathway channels 174 and 176, lens components 186 and 188 or window 172 may be within sample flow channels 198, within sample mixing chamber 200 or within sample flow channel 218 when sampling and measurement unit 160 is assembled. In other embodiments, the focal region may alternatively be any other portion of sample measurement unit 190 or cap 212.

With reference again to FIG. 1, circuitry 130A-130D of sensor device 110, also referred to collectively and individually herein as circuitry 130, comprises one or more processing devices 250, an IO interface 252 and memory 254.

Processing device(s) 250 may comprise, for example, a processor, a microprocessor, a microcontroller (MCU), an application-specific integrated circuit (ASIC), a field-programmable gate array (FPGA), a graphics processing unit (GPU), a printed circuit board (PCB), or any other processing device.

Circuitry 130 may also comprise any of an analog-to-digital converter (ADC), a digital-to-analog converter (DAC), sensor interfaces, motor controllers, a power supply, or any other type of circuitry, as well as portions or combinations of such circuitry elements. Circuitry 130 may comprise electrical fault protection circuitry in order to ensure resilience to electrical noise commonly found in industrial facilities. One or more of light source 146, optical sensors 150 and brightness detector 148 may be physically coupled to circuitry 130 or may be attached to housing 120 in another manner.

Memory 254 may comprise, e.g., random access memory (RAM), read-only memory (ROM), flash memory or other types of memory, in any combination. The memory and other memories disclosed herein should be viewed as illustrative examples of what are more generally referred to as “processor-readable storage media” that may store executable program code of one or more software programs. In some embodiments, memory 254 may store one or more software files including, e.g., a computation and control module 256 that is executable to implement a calibration framework and perform one or more computational algorithms that control the operation and processing of sensor device 110 and one or more calibration profiles 258 that may be used when processing sensor data 260 obtained by optical sensors 150. Sensor data 260 generated by optical sensors 150 may also be stored in memory 254. In some embodiments, memory 254 may also or alternatively comprise removable storage media such as, e.g., a flash drive, USB drive, external hard drive or other removable storage media for storing sensor data 260. In some embodiments, for example, a technician may periodically remove the removable storage media, download sensor data 260 and reattach the removable storage media.

IO interface 252 may comprise a wired or wireless communication interface. In some embodiments, IO interface 252 may comprise a serial communication interface such as, e.g., a serial communication interface in accordance with RS-485 standards. Other wired interfaces may alternatively be utilized. In some embodiments, sensor device 110 may communicate with control station 300, computing system 400, sensor data storage 500, or industrial process control equipment using a standardized protocol such as, e.g., MODBUS or another standardized protocol. In other embodiments, any other communication protocol may also or alternatively be utilized.

In some embodiments, electrical connections may be vulnerable to corrosion from an acidic environment. Sensor device 110 may be configured for non-electrical communication with the host computer, such as RF telemetry or fiber optic communication. For example, sensor device 110 may be configured to receive power without electrical communication, e.g., through a fiber optic cable or an on-board energy harvesting system.

In some embodiments, circuitry 130 may be divided into two sections which are in electrical communication, but thermal isolated, in order to inhibit the power supply from influencing the temperature of the optical sensors 150 and instrumentation circuitry. While four circuit boards are illustrated for circuitry 130, other configurations including fewer circuit boards or a larger number of circuit boards with the same or alternative functionality may also or alternatively be utilized. As an example, in some embodiments, the functionality and components of circuitry 130A and 130B may be implemented on a first circuit board and the functionality of circuitry 130C and 130D may be implemented on a second circuit board. Any other combination of circuit boards and functionality may alternatively be utilized.

The environment occupied by sensor device 110 may contain corrosive or biological substances that act to degrade the components of sensor device 110 over time. Sensor device 110 may be designed to anticipate interface surfaces that may be subject to destructive substances. For example, in some embodiments, sensor device 110 may comprise some internal components that may be susceptible to such environments but may utilize other materials for those components exposed such environments to inhibit the degradation and corruption of measurements when exposed to the fluid stream environment. For this reason, exterior surfaces of sensor device 110 or those components being exposed to the fluid stream or other hazardous or corrosive environments may be formed of materials that may be resistant to these environments such as, e.g., fluoropolymers, e.g., Polytetrafluoroethylene, PVDF, etc., plastic materials, metal or glass-coated graphite, ceramics or other materials as needed to facilitate the deployment of sensor device 110 within those environments, to extend the life of sensor device 110 within those environments or for any other purpose. In some embodiments, inner cavities or components of sensor device 110 may be filled with corrosion-inhibiting substances such as oil or epoxy where feasible in order to reduce the occurrence of degradation in the components.

With reference again to FIGS. 1-3, control station 300 comprises one or more metering pumps 302, processing device(s) 304, memory 306, an IO interface 308, a network interface 310, valves, transducers or any other components that may be utilized to support and control fluid and data connections with sensor device 110. Processing device 304, memory 306 and IO interface 308 may function in a similar manner to those components described above for sensor device 110. One or more of the electrical components of control station 300 may also or alternatively be mounted or integrated into one or more circuit boards 320, e.g., forming an industrial computer. In some embodiments, a single control station 300 may service several sensor devices 110.

Control station 300 may comprise several precise metering pumps 302, such as peristaltic pumps or piston pumps, and may comprise one or more refillable reservoirs 322 for storing reagents or other fluids. Reservoirs 322 may be located internal or external to the case of control station 300 depending on factors such as, e.g., operating environment, reagent characteristics, etc. For example, a reagent that may break down when exposed to light, heat or another environmental variable may be stored in an appropriate manner, e.g., in a blackout reservoir, in a climate-controlled reservoir or in any other manner. Control station 300 may also or alternatively be connected with piping to sources of reagents or other fluids that are located at a central reservoir, larger storage tanks or other sources of reagents or fluids. For example, a central reservoir may be located at any distance from the metering site such as, e.g., in a laboratory.

Processing device 304 is configured to collect and store sensor data 318 from one or more sensor devices 110, e.g., via IO interface 308, and send commands to one or more sensor devices 110 during reagent metering according to pump control module 312 stored in memory 306. Sensor data 318 may comprise raw sensor data, e.g., digital or analog signals output by optical sensors 150 or other components of circuitry 130A, sensor data that is pre-processed by circuitry 130 such as removal of noise, selection of peak values, etc., or any other form of sensor data received from sensor devices 110. In some embodiments, processing device 304 may be configured to perform computation module 316 on sensor data 318 received from a sensor device 110 to determine a concentration of a particular analyte. The output of computation module 316 may be stored as part of the corresponding sensor data 318. In some embodiments, the sensor data 318 may be received from the sensor device 110 after the sensor device 110 has performed concentration processing logic where, for example, sensor data 318 may comprise one or more of raw sensor data, processed sensor data, and concentration values for the target analyte.

Memory 306 comprises on-board memory and also, in some embodiments, removable storage media such as, e.g., a flash drive, USB drive, removable hard-drive or SSD, or any other removable storage media. In some embodiments, for example, sensor data 318 may be stored in the on-board memory of control station 300, in the removable storage media or both. For example, if the target environment where measurements are being taken is located in a remote area without network connectivity, sensor data 318 stored in the removable storage media may be obtained by a technician for later processing, e.g., using a portable computing device. The technician may then provide the sensor data 318 to computer system 400 once the technician returns to a network connected location.

Network interface 310 may comprise a wired or wireless communication interface that is configured to communicate with sensor device 110, computing system 400 and sensor data storage 410, e.g., via network 118.

In some embodiments, processing device 304 may also be configured to push updated calibration profiles 258 to sensor device 110 for storage on sensor device 110 and for use by sensor device 110 in future measurements.

One fluid that may be utilized by the sensor device 110 is water. For example, pure water may be used to purge the sample mixing unit 190 of mixed fluid in between individual measurement cycles. High-purity water such as distilled water or reverse-osmosis water may be used in order to ensure that contaminants in the purging water do not cause false signals. In other embodiments, the purge liquid may be any other pure liquid, such as an organic solvent. In some embodiments, pumps may circulate fluids from the fluid stream for purging.

Water, being an incompressible fluid, may also provide hydraulic energy transfer functionality in system 100. Metering pumps 302 contained in control station 300 are able to produce precise fluid displacements. Displacements that are generated in the control station 300 are conserved through the tubing leading to sensor device 110 and are transferred as alternating flow pulses to the sample mixing unit 190. Metering pumps 302 may be under computer control by processing device 304 to produce alternating flow at high frequency, for example, at sonic frequency or ultrasonic frequency. Alternating flow pulses transduced by computerized metering pumps may be used to induce eddy currents and mixing within the sample mixing unit 190 of each sensor device 110.

An example reagent circuit of control station 300 may comprise an intake tube of a metering pump 302, such as a piston syringe pump, valve-less metering pump, peristaltic pump, diaphragm pump or another pump, connected to a reservoir 322 storing a reagent. Metering pump 302 may be driven by an actuator under control of pump control module 312, such as a servo motor. Reservoir 322 may comprise, for example, a Pyrex bottle, a sealed container such as a canister that is pressurized with inert gas, a sealed stainless-steel tube that contains pressurized reagent being supplied from a nearby laboratory or any other type of reservoir 322 which may be selected based on the environment surrounding the fluid stream. Metering pump 302 acts to dose a specific volume of fluid into tubing 112 for delivery to sensor device 110.

In some embodiments, a pressure wave transducer 324 (FIG. 3) may be connected in parallel with fluid tubing 114. Pressure wave transducer 324 may comprise a linearly actuated pressure surface, such as a piston or diaphragm which acts to displace a specific volume of fluid in fluid tubing 114 as the pressure surface travels from its minimum stroke position to an extended position. The pressure surface may be driven by a computer-controlled actuator such as a solenoid, voice coil, piezoelectric actuator, ultrasonic transducer, or a rotary motor that is connected to a cam shaft. Pressure wave transducer 324 comprises a sealed chamber with at least one surface that is actuated in order to produce volumetric displacement and pressure waves. The pressure waves may have a symmetrical alternating displacement waveform such as, e.g., a sine wave.

Fluid tubing 114, being connected to pressure wave transducer 324, has a flow rate that is equal to the displacement generated by metering pump 302 in addition to displacement generated by pressure wave transducer 324. By utilizing both metering pump 302 and pressure wave transducer 324, it is possible for control station 300 to produce fluid flow patterns that comprise alternating sine waves that are superimposed on precise computer-controlled positive displacement flows.

Similar functionality may also be utilized to control the flow of reagent through reagent tubing 112.

With reference again to FIG. 1, computing system 400 may comprise one or more processing device(s) 402, memory 404, a network interface 406 or any other components commonly used by a computing system. Processing device 402, memory 404 and network interface 406 may function in a similar manner to those components described above for sensor device 110 and control station 300. In some embodiments, computing system 400 may store calibration profiles 258 that are utilized to calibrate sensor device 110. For example, the calibration profiles 258 may be generated based on lab-based analytical testing to configure and calibrate the parameters of sensor device 110. Calibration profiles 258 may be pushed down to control station 300 for storage or transfer to sensor device 110 or directly to sensor device 110.

Sensor data storage 410 comprises data storage devices or data storage systems that are configured for storage of large volumes of sensor data that may be utilized by computing system 400. Example data storage devices that may be utilized by sensor data storage 410 include hard disk drives (HDD), solid state drives (SSDs) or other storage technologies. In some embodiments, the data storage devices may be implemented using non-volatile memory (NVM) devices such as flash memory. Other types of NVM devices that can be used to implement at least a portion of the data storage devices include non-volatile random access memory (NVRAM), phase-change RAM (PC-RAM) and magnetic RAM (MRAM). These and various combinations of multiple different types of NVM devices may also be used. The particular storage devices used may be varied in other embodiments, and multiple distinct storage device types may be used within a data storage system. The term “storage device” as used herein is intended to be broadly construed, so as to encompass, for example, flash drives, solid state drives, hard disk drives, hybrid drives or other types of storage devices. Example data storage systems that may be utilized by sensor data storage 410 include network-attached storage (NAS), storage area networks (SANs), direct-attached storage (DAS) and distributed DAS, as well as combinations of these and other storage types, including software-defined storage. Other types of data storage systems that can be used including all-flash and hybrid flash storage arrays, software-defined storage systems, cloud storage systems, object-based storage systems, and scale-out NAS clusters and associated accelerators. Combinations of multiple ones of these and other data storage systems can also be used in implementing a given data storage system in an illustrative embodiment.

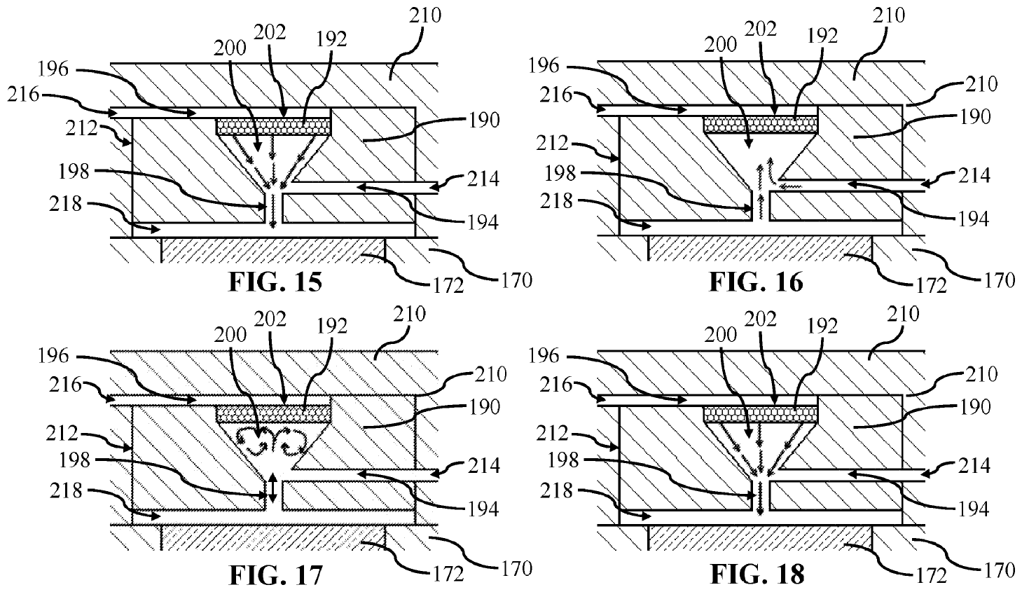

With reference to FIGS. 15-18, the use and function of sample mixing unit 190 is described in an embodiment. One function sample mixing unit 190 is to react a predetermined volume of the fluid stream with a predetermined volume of reagent. The components of sample mixing unit 190 may be designed to withstand adverse characteristics of the fluid stream, to inhibit or resist degradation and clogging and have other features that are configured to support the sampling process.

Each sensor device 110 comprises a sample mixing unit 190 that is configured to mix a predetermined volume of the fluid stream with a predetermined volume of reagent and to optically interface the mixed sample with the sensor device 150.

Cap 210 and sample mixing unit 190 are immersed within a fluid stream with fluid flowing past cap 210. Cap 210 is configured to cause turbulence in the fluid stream which creates a pressure differential between the upstream and downstream sides of the cap 210.

Opposing orifices 220 (FIG. 20) of the cap 210 provide access to sample flow channel 218 and allow a portion of the fluid stream to enter cap 210. In an embodiment, sample flow channel 218 is a flat, pancake shaped void in cap 210, e.g., providing fluid flow from orifice 220 to orifice 220 as a substantially flat sheet of fluid. In other embodiments, sample flow channel 218 may have other shapes or configurations. Orifices 220 may comprise large rectangular slits that allow for abundant flow of the fluid stream through sample flow channel 218 along the planar surfaces of cap 210. In other embodiments, orifices 220 may be sized to accept or limit the fluid stream flowing through sample flow channel 218 to a target flow rate. In some embodiments, orifices 220 are radially opposed. In some embodiments, a cross-sectional area of sample flow channel 218 may be greater than a surface area of the orifices 220, e.g., in order to prevent clogging by particles or debris of the fluid stream. In other embodiments, the cross-sectional area of sample flow channel 218 may alternatively be smaller than the surface area of orifices 220. In some embodiments, orifices 220 may be covered by a screen comprising openings that are smaller than the cross-sectional area of the sample flow channel 218. Fluid from the fluid stream is able to readily pass through the sample flow channel 218 and return to the fluid stream via orifices 220.

In some embodiments, powered doors or valves may be actuated to close off orifices 220 during measurement and isolate any fluid stream sample contained within measurement and sensing unit 160. The doors then may be opened after measurement to allow the fluid stream to continue flowing through sample flow channel 218 and obtain a new fluid stream sample.

Sample flow channel 218 is disposed adjacent to window 172 and sensor body 170. In some embodiments, window 172 may be polished such that window 172 comprises a relatively smooth surface that is intended to be corrosion resistant and may be coated by films providing favorable anti-microbial, anti-friction and optical characteristics. Window 172 may also be uncoated and comprised of glass, quartz, sapphire, silicon or any other transmissive material. The polished surface allows for ready flow of fluid and particles through sample flow channel 218. Window 172 may contain flat surfaces, concave surfaces, convex surfaces, or parabolic surfaces serving to focus or direct light through window 172.

The fluid in sample flow channel 218 may be positioned at the focal region of the optical instruments that are positioned below window 172 such as, e.g., lenses 186, filters 152 and optical sensors 150. In some embodiments, the focal region of the optical instruments may also or alternatively be located within sample flow channel 198 or sample mixing chamber 200. In some embodiments, the location of the focal region may be configured based on the anticipated or actual flow rate of the fluid stream through sample flow channel 218. For example, where a higher flow rate is anticipated or measured, the focal region may be moved or set closer to sample mixing chamber 200 within sample flow channel 198 or sample flow channel 218 while for a lower flow rate, the focal region may be moved or set closer to window 172 within sample flow channel 198 or sample flow channel 218.

The upper surface of sample flow channel 218 is formed by the sample mixing unit 190, which in some embodiments may be circular in shape. The surface of sample mixing unit 190 that is in contact with the fluid stream flowing through sample flow channel 218 may comprise a low-friction and chemically-inert material such as a fluoropolymer or graphite. Other materials may alternatively be utilized.

Sample flow channel 198 fluid couples sample flow channel 218 to sample mixing chamber 200. In some embodiments, sample flow channel 198 may be oriented perpendicular to the direction of flow in sample flow channel 198. Sample flow channel 198 may have a cross sectional area that is smaller than the surface area of the sample flow channel 218. The narrow, pancake-shape of sample flow channel 218 causes the flow of fluid stream to be laminar. Laminar flow past the perpendicularly arranged sample flow channel 198 may cause a shearing effect on the fluid stream with fluid contained in sample flow channel 198.

As mentioned above, sample mixing chamber 200 is fluidly coupled to sample flow channel 218 by sample flow channel 198. Sample flow channel 198 is configured to provide a sufficient amount of separation distance and a sufficiently small cross-sectional area between sample mixing chamber 200 and sample flow channel 218 in order to inhibit significant amounts of diffusion or washing of fluid stream materials into the sample mixing chamber 200 which may corrupt the accuracy of measurements.

Because the fluid contained in sample mixing chamber 200 is representative of the fluid stream at the time when it was drawn into the sample mixing chamber 200 and the measurement process is much faster than the leakage rate through sample flow channel 198, it is possible to analyze a fixed sample volume of the fluid stream without the use of actuated valves that would otherwise be needed to temporarily seal-off sensor device 110 from the fluid stream.

Sampling and measurement unit 160 is configured to rapidly disperse a fixed-volume of reagent into an isolated portion of the fluid stream. The exposed portions of sampling and measurement unit 160 may be made from corrosion-resistant materials such as stainless steel, fluoropolymers or other components, depending on the fluid stream and operating environment. The geometry of sample mixing chamber 200 may be structured to create cross-currents or eddy currents in the presence of an alternating displacement pressure wave produced by control station 300. In an embodiment, the sample mixing chamber 200 comprises a conical shape with sample flow channel 198 being located at the tip of the cone. Other configurations may alternatively be utilized.

At the opposite end of the sample mixing chamber 200 is an opening to a fluid distribution chamber 202, e.g., a circular opening in some embodiments. A porous member 192 such as, e.g., a sintered fluoropolymer disk, plastic screen, a membrane or another porous member, is positioned within fluid distribution chamber 202 across the opening and sealed around the circumference to the fluid distribution chamber 202 such that fluid flowing between fluid distribution chamber 202 and sample mixing chamber 200 is forced through the porous material. When fluid flows through the porous member 192, a backpressure may be exerted evenly across the surface which causes an equalization of the flow rate across the surface and through porous member 192. Porous member 192 may comprise or be formed of porous matrix materials such as, e.g., plastic, organic polymer, elastomer, cellulose, stainless steel, graphite, ceramic or other porous matrix materials.

As mentioned above, fluid mixing chamber 200 is fluidly coupled to fluid, reagent and sample channels. Fluids such as water are delivered from fluid flow channel 196 to fluid mixing chamber 200 via fluid distribution chamber 202 and porous member 192. Reagents are delivered to fluid mixing chamber 200 from reagent flow channel 194 and samples of the fluid stream are delivered to fluid mixing chamber 200 via sample flow channels 218 and 198.

When a fluid such as water is pumped via fluid distribution chamber 202 through the large end of fluid mixing chamber 200 toward the small end, flow is mostly laminar, with flow velocity increasing as fluid mixing chamber 200 tapers. In this manner, it is possible to completely purge fluid mixing chamber 200 by pumping in one direction, with water or another purging fluid entering through porous member 192 and exiting through sample flow channel 198 the small orifice into the fluid stream via sample flow channel 218 and orifices 220. The use of smooth and low-friction surfaces on the exposed portions of sensor body 170, sample mixing unit 190 and cap 210 may further assist in the purging or self-cleaning of particles or residue from sampling and measurement unit 160.

When fluid is pumped through fluid flow channel 196 in reverse, sample fluid from the fluid stream is drawn into the sample mixing chamber 200 from sample flow channel 218 via sample flow channel 198. In some embodiments, computation and control module 256 of sensor device 110 or pump control module 312 of control station 300 may be configured to intelligently modulate flow patterns within the sample mixing chamber 200 by modulating the flow rate and flow direction. For example, when pumped slowly, fluid entering sample mixing chamber 200 through sample flow channel 198 is able to expand radially into the widening conical void of sample mixing chamber 200. The conical shape results in decreasing flow velocity of the sample, causing a slight pressure gradient from the entry point of the sample near sample flow channel 198 to the porous member 192. In this manner, it is possible to fill sample mixing chamber 200 with mostly fluid stream fluid by pumping slowly in reverse.

If a reverse flow is rapidly pulsed, fluid stream fluid is jetted may be through sample flow channel 198 into sample mixing chamber 200. The inertia of the high-velocity liquid carries it past the tapered middle region of sample mixing chamber 200 towards the large end and porous member 192, forming eddy currents within the conical void, which may be toroidal in shape.

In some embodiments, the volume and cross-sectional area of sample flow channel 198 may be designed based on a target flow rate during such pulsing. For example, in some embodiments, the length or diameter of sample flow channel 198 may be selected so that it has a volume that is greater than the displacement volume of the pulses. Likewise, the pulses may be tuned so that the displaced volume is less than the channel volume of sample flow channel 198. In this manner, oscillating flow pulses may be utilized without ejecting fluid from sample mixing chamber 200 into the fluid stream. In some embodiments, the magnitude and frequency of alternating/oscillating flow pulses may also be tuned based on the viscosity of the fluids being utilized in order to achieve specific eddy current patterns and maximize mixing action.

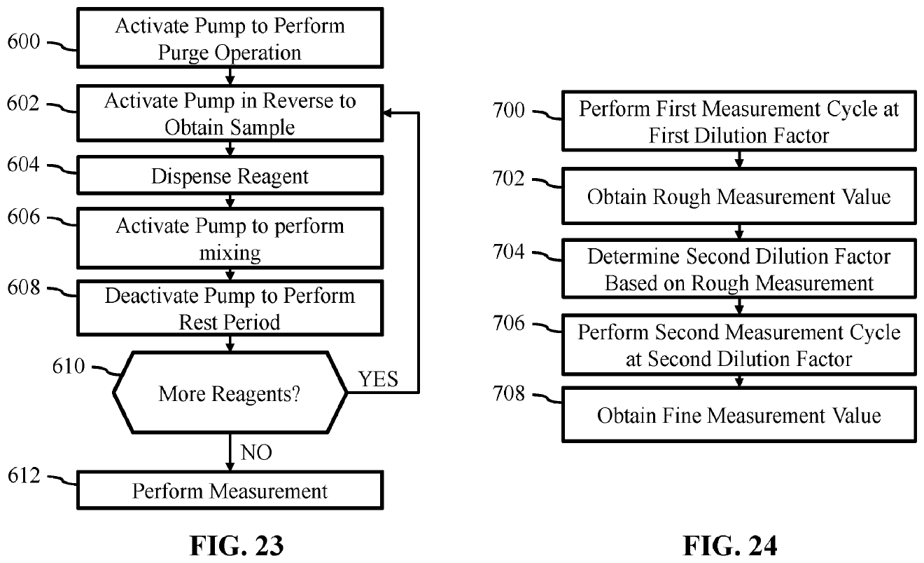

With reference now to FIG. 23, an example sampling and measurement process using system 100 is described. The example process of FIG. 23 comprises steps 600 through 612 although additional or fewer steps may alternatively be implemented. The sampling and measurement process of FIG. 23 may be performed by computation and control module 256, pump control module 312, or by a combination of computation and control module 256 and pump logic 312.

At step 600, during power-on or when sensors are commanded to begin measurement, a purge operation is initiated and a metering pump 302 is activated, e.g., as shown in FIG. 15. The activated metering pump 302 pumps a purge fluid such as, e.g., water or another purge fluid, through the sample mixing chamber 200 from fluid distribution chamber 202 to sample flow channel 218 and the fluid stream via sample flow channel 198. The volume of purge fluid may be equal to or greater than the total volume of sample mixing chamber 200. For example, the amount of purge fluid pumped may be sufficient to ensure that little or no fluid stream sample is left within sample mixing chamber 200.

At step 602, the measurement cycle begins. Metering pump 302 is activated to displace the fluid contained in sample mixing chamber 200 in the reverse direction, e.g., slowly as previously mentioned, with a volume precisely controlled to match the volume of sample mixing chamber 200, e.g., as shown in FIG. 16. In some embodiments, the displacement volume may also be a fixed quantity that is less than the volume of sample mixing chamber 200 in order to inhibit fluid stream contaminants from entering porous member 192. Fluid distribution chamber 202 may maintain a purge fluid buffer region that reduces the need for cleaning and maintenance of sample mixing chamber 200. The reverse direction pumping may also be utilized to dilute the potency of a fluid stream sample to be measured by a ratio that is computer controlled. For example, if sample mixing chamber 200 is configured with a volume of 10 microliters, a reverse-draw of a 2-microliter portion of the fluid stream may be utilized to create a 20% solution of the sample to the purge fluid. The time at which sample is drawn into sample mixing chamber 200 may be recorded by one or both of processing devices 250 and 304 for later pairing with the measurement data for this sample.

At step 604, a metering pump 302 is activated to dispense reagent into sample mixing chamber 200 via reagent flow channel 194, e.g., as shown in FIG. 16. In some embodiments, the total volume of fluid entering sample mixing chamber 200 is controlled such that an equal volume of fluid both enters and exits sample mixing chamber 200, regardless of source and sink. For example, the pumping may be controlled such that an amount of reagent being pumped into sample mixing chamber 200 is about equal to an amount of fluid being removed from sample mixing chamber 200 either by forward or reverse displacement of purge fluid from fluid distribution chamber 202. As an example, if sample mixing chamber 200 comprises a 10-microliter volume full of purge fluid after step 600, the metering pump 302 controlling the flow of purge fluid may be configured to reverse-draw 2-microliters of sample into sample mixing chamber 200 while a metering pump 302 controlling the flow of reagent may be configured to positively supply 2-microliters of reagent into sample mixing chamber 200. In this example, in order to accomplish the target volumes of 2-microliters of fluid stream sample and 2 micro-liters of reagent, the metering pump 302 controlling the flow of purge fluid may be configured to reverse displace 4 microliters in total, e.g., 2 microliters for the reagent and 2 microliters for the fluid stream sample. In this manner, reagent may be positively pumped into sample mixing chamber 200 while a target amount of fluid stream sample is drawn into sample mixing chamber 200 by negative pressure at the same time. In some embodiments, the fluid stream sample may be drawn into sample mixing chamber 200 prior to the dispensing of the reagent. In other embodiments, the fluid stream sample may be draw into sample mixing chamber 200 at substantially the same time as the dispensing of the reagent. While described as separate steps, in some embodiments, steps 602 and 604 may be performed together. Laminar flow produces pockets of fluid in sample mixing chamber 200 prior to mixing. For this reason, precise amounts of process sample, reagent and purge fluid can be dispensed into the mixer vessel.

At step 606, mixing is performed on the fluid in sample mixing chamber 200 as shown in FIG. 17. During mixing, the metering pump 302 connected to reagent flow channel 194 remains powered off and flow is restricted by the pumps or check valves that are incorporated with control station 300 or sensor device 110. The metering pump 302 connected to fluid flow channel 196 is activated to produce a fixed-displacement oscillating flow, resulting in an alternating pressure wave oriented in-line with the conical vessel of sample mixing chamber 200. In some embodiments, for example, the initial flow pulse may be equal to one-half the peak-to-peak displacement, followed by a repeating alternation and ending at a zero net-displacement. This oscillation pattern minimizes displacement of the mixed solution toward the fluid stream.

Negative displacements of the oscillating waveform may be more rapid than positive displacements in order to maximize eddy current formation and minimize ejection of mixed solution out of the fluid mixer. In other embodiments, the displacements may be performed at the same speed or rate or with more rapid positive displacements than negative displacements. The peak-to-peak displacement may also be minimized, while adequately causing eddy currents to form in sample mixing chamber 200.

At step 608, a rest period is performed in which no metering pumps 302 are activated. The rest period may allow for a reaction between the reagent and the fluid stream sample to occur. During the rest period, all pumps are inactive such that the mixed fluid is substantially isolated from the fluid stream.

At step 610, a determination is made of whether or not additional reagents need to be added. For example, pH buffer or surfactant solutions may be mixed with the sample in order to enhance the optical properties of activated sample. If additional reagents need to be added, the process returns to step 602. Otherwise, the process proceeds to step 612.

At step 612, the reacted fluid stream sample is measured. Light source 146 and optical sensors 150 are activated in conjunction with the metering pump 302 connected to fluid flow channel 196 to drive the reacted fluid stream sample to the focal region, e.g., through sample flow channel 198 and into sample flow channel 218.

In some embodiments, the reacted sample may be dispensed at a low rate through sample flow channel 198 and into sample flow channel 218, adjacent to the window 172. The light from light source 146 may interact with the fluid stream sample in sample flow channel 198 and sample flow channel 218 such that the fluid stream sample fluoresces, reflects, absorbs or otherwise interacts with the light in a measurable manner to producing a unique optical signature that is measurable by optical sensors 150.

In some embodiments, the reacted sample may be dispensed at a high flow rate through sample flow channel 198 and into sample flow channel 218, adjacent to window 172. As an example, if the fluid stream passing through sample flow channel 218 has a high flow rate, the mixed sample may be quickly drawn away from the focal region. In such a case, dispensing the reacted sample at a high flow rate may cause the reacted sample to jet out of sample flow channel 198, cut through the fluid stream and engage with or contact window 172, enabling light from the reacted sample to be measured.

The optical instruments may be configured to strobe measurements at high frequency, for example, 100 Hz, while the metering pump 302 slowly displaces the contents of sample mixing chamber 200, e.g., over the course of 1 second or any other period of time. The resulting measurements may be processed by circuitry 130A, by computation and control module 256 of sensor device 110, by computation module 316 of control station 300 or by any other computing system. For example, the measurements may be averaged, the peak values may be recorded or other computations may be performed. This optical data serves as the raw measurement for computing analyte concentration.

The particular processing operations and other system functionality described in conjunction with the flow diagram of FIG. 23 are presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement the disclosed embodiments.

As described herein, reagents are chemicals which interact with analytes in order to induce a uniquely identifiable optical signal. Thousands of reagents which allow for the quantification of specific chemicals, molecules, elements or other materials in fluids by photonic instruments have been developed and may be utilized by system 100.

A number of categorical modes of photonic quantification are available depending on the particular reagent and analyte. For example, some reagents are configured to induce emissions or fluorescence when in the presence of an analyte under certain circumstances. As an example, some reagents may be configured to cause an analyte to emit light while other reagents may themselves emit light conditionally in the presence of an analyte. In some embodiments, light of a particular wavelength or wavelength range emitted from light source 146 may interact with the reagent, the analyte or both to cause the emission or fluorescence. In other embodiments, light of a particular wavelength or wavelength range may be emitted by the light source 146 and the absorption characteristics of either the analyte or reagent may be quantified by sensor devices 150. The photonic absorption characteristics of either the reagent or analyte may be altered by their interaction with one another and thereby be quantifiable by sensor device 110. System 100 provides the ability to readily configure sensor devices 110 and control stations 300 to optically analyze mixed samples using one or more modes simultaneously, as will be described in more detail below.

One example type of reagent contains metal-organic-framework (MOF) nanoparticles that may be dispersed in a liquid solution to produce a metal ion sensor reagent. Metal ions, which are emissive when excited, produce narrow emission peaks. These peaks occupy a relatively narrow portion of the spectrum and the relative luminescence of emissions in these spectral regions may be proportional to the concentration of the respective metal ion. However, metal ions generally are not fluorescent on their own, because they do not absorb enough photonic energy to transfer electrons to the excited state. A MOF reagent acts as a fluorescence sensitizer for metal ions and may be utilized by sensor device 110 to detect concentrations of metal ions of a particular analyte in the fluid stream sample. Such a sensor device 110 may act as an active-sensitization fluorometer. When a sample solution containing target metal ions is mixed with a MOF sensitizer reagent, the MOF nanoparticles bind or link to the target metal ions and absorb light emitted by light source 146, e.g., ultraviolet light or another wavelength of light depending on the characteristics of the MOF. The MOF nanoparticles transfer the absorbed energy to the linked metal ions, causing the metal ions to emit light at particular wavelengths specific to the metal ions themselves. In this manner, a mixed solution of fluid stream sample and MOF sensitizer reagent may produce an assortment of emission peaks that are representative of the metal ions that are present. The emission peaks for each target metal ion may then be selectively detected by optical sensors 150, e.g., through the use of filters 152 that are each specifically tailored to an emission peak wavelength or wavelength range corresponding to a target metal ion.

Another example type of reagent contains fluorescent sensor proteins, e.g., in a water-based mixture. Genetically encoded fluorescent sensor proteins, or sophisticated biosensor molecules comprising several linked proteins may be manufactured. These engineered molecules may be highly selective to bind with a specific analyte molecule and cause a conformational change in the protein structure which is evident when analyzed optically. For example, a biosensor molecule designed for optical detection of sulfonamides may fluoresce when exposed to ultraviolet light produced by the light sources 146. In this example, the biosensor molecule may be configured to emit two distinct spectral peaks centered on 570 nm and 670 nm respectively. When a sample solution containing sulfonamide is mixed with a reagent comprising the biosensor molecule, emissions at the 570 nm peak become more intense, while emissions at the 670 nm peak become less intense. In this manner, a mixed solution of reagent and sulfonamide may be measured by optical sensors 150 to quantify the change in luminescent intensity ratio between the 570 nm and 670 nm peaks as the raw optical data by which a concentration of sulfonamide is computed. In this example, filters 152 may be configured for the 570 nm and 670 nm peaks, or a range around each peak.

Another example type of reagent contains engineered phosphorous-nitrogen co-doped carbon nanodots (CNDs), e.g., in a water-based mixture. CNDs are fluorescent under ultraviolet light and emit a luminescent signature that is centered on 500 nm which closely overlaps the absorption spectrum of cobalt molecules. When a fluid stream sample containing cobalt ions is mixed with a reagent comprising phosphorous-nitrogen co-doped CNDs, fluorescent emissions of the phosphorous-nitrogen co-doped CNDs are absorbed by the cobalt ions. In this manner, a mixed solution of a specific quantity of reagent comprising a particular concentration of phosphorous-nitrogen co-doped CNDs and a known volume of fluid stream sample may be illuminated by light source 146 and measured by optical sensors 150 determine the difference in expected radiant intensity at 500 nm and measured radiant intensity at 500 nm. This difference may then be utilized to calculate the concentration of cobalt molecules in the fluid stream sample and the fluid stream itself. Engineered CNDs or other synthetic reagents may be produced with specific fluorescent peaks in order to overlap with absorption peaks of a targeted analyte in a similar fashion, providing a broad range of reagents for use with a variety of target analytes. In some embodiments, for example, sensor device 110 may be pre-calibrated for use with a particular CND to determine the expected radiant intensity at the particular wavelength.

In another example, fluid stream samples may contain analytes with inherent properties that are quantifiable optically but may also contain a contaminant material which acts to interfere with or otherwise inhibit the measurement of the inherent optical signal. For example, a sensor device 110 may be configured to measure the concentration of carbon dioxide that is dissolved in the water of a river. For example, sensor device 110 may illuminate the fluid stream sample using a narrow band light source 146 that is centered on 1667 nm with a known radiant intensity. Sensor device 110 may then measure the amount of 1667 nm light absorbed by the fluid stream sample. However, the water may also contain organic ions which also absorb the 1667 nm light. These organic ions may cause a false-positive signal in the measurement. In such a case, sensor device 110 may be configured to dispense a pH buffering reagent into the fluid stream sample, e.g., in sample mixing chamber 200 as described above. One example pH buffering reagent may be potassium hydroxide although other reagents may alternatively be utilized. The pH buffering reagent causes the suspended organic materials to precipitate out of solution. The mechanically separated liquid component of the fluid stream sample may then be analyzed for carbon dioxide composition without the interference from the organic ions.

System 100 comprises an easily customizable modular design that is configurable and usable in a wide variety of use cases with a wide variety of fluid stream compositions, operating environments, target analytes and reagents. The modular design allows the components and configuration of system 100 to be tailored specifically to the task at hand during assembly and the software components to be easily upgraded in the field based on later data and analysis generated by system 100 itself, by lab testing or from any other source.

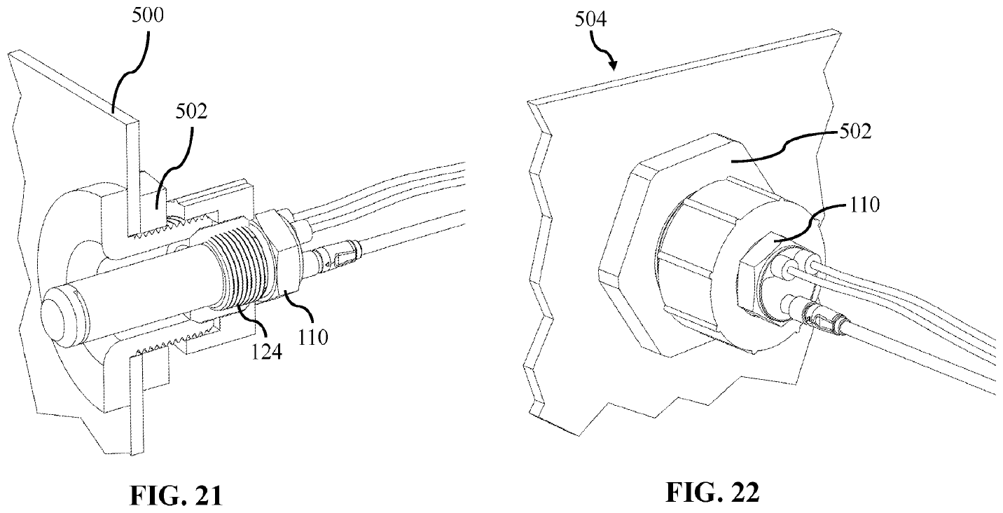

The modular design is built on a ruggedized platform comprising core components common to some or all implementations of sensor device 110 and control station 300. As an example, core components of sensor device 110 may comprise sensor body 170, sample mixing unit 190, cap 210 and portions of housing 120. Some components, such as sensor body 170, may have a number of core configurations, e.g., depending on a required length of sensor body 170 to ensure that sample mixing unit 190 and cap 210 are disposed in the fluid stream (see FIGS. 20 and 21 as examples). Core components of control station 300 may comprise, for example, standardized pumps, motorized valves, power supplies and computing components.

Modular components may be added to the core components based on a target use case, target analyte being measured, reagent being utilized, fluid stream composition, operating environment, or any other factors.

One example modular component is the reagent. The reagent may be selected based on any of the above factors and may be installed at control station 300 for dispensing to sensor device 110.

Another example modular component is filters 152. A variety of filters 152 may be available for selective assembly with sensor device 110. For example, the filters 152 to be assembled to optical sensors 150 on circuitry 130A may be selected based on the above factors including, e.g., target use case, target analyte being measured, reagent being utilized, fluid stream composition, operating environment, or any other factors. Optical filter materials, for example, multi-layer coated glass bandpass filters in some embodiments, are configured to block transmission of nearly all light wavelengths except for a specific portion of the electromagnetic spectrum. As an example, if the mixture of reagent and analyte is configured to emit, reflect or absorb light at particular wavelengths or ranges of wavelengths, also referred to herein as wavelength bands, corresponding filters 152 for those wavelength bands may be selected for assembly with optical sensors 150 on circuitry 130A.

A filter 152 arranged in combination with a corresponding sensor element 150 forms a system for quantifying the targeted optical signal. A reagent, analyte or both may produce several wavelength bands that are distributed separately along the electromagnetic spectrally. Some or all of these wavelength bands may be quantified by a corresponding paired optical sensor 150 and filter 152. The modular filters 152 may have a similar size and shape allowing sensor devices 110 to be specialized by easily installing the appropriate filter 152 for the particular use.

Another example modular component is the calibration profiles 258 which may be stored in memory 254 of sensor device 110, stored in memory 306 of control station 150, stored in memory 404 of computing system 400 or stored in any other location. Configuration profiles 258 are utilized by computation and control module 256 to configure the measurement process. Calibration profiles 258 may also be utilized by pump control module 312 to control the delivery of reagents or other fluids to sensor device 110. For example, calibration profiles 258 may comprise 2D tables that relate the relative radiant intensity to wavelength for a given reagent in the presence of a target analyte. Calibration profiles 258 may be stored as comma-separated variable (CSV), JSON, or any other data file format. Processing device 250 may access several calibration profiles 258 during the measurement process in order to accurately compute a calibrated concentration of an analyte from raw optical signals, for example, in units of parts-per-million. As an example, calibration profiles 258 may comprise information such as, e.g., information about the optical filters 152 that have been installed, a 2D spectral plot of the reagent in the presence of the analyte at a known concentration, a 2D spectral plot of the optical signature of a known contaminant molecule, a 2D plot of a current of the optical sensor, e.g., photodiode, relative to temperature or any other information that may be utilize to control the operation of sensor device 110 or control station 300 or to perform computation on the signals output by optical sensors 150.

Another example of modular components are computation and control module 256, pump control module 312 and computation module 316 that may be executed by processing devices 250 and 304. These modules comprise algorithms and functionality that may be specifically tailored to the particular use case including the selection of particular calibration profiles 258 to be used and control of the measurement process by which fluid stream samples are isolated, mixed, reacted, excited, measured and analyzed. For example, a variety of modules may be developed that are configured to handle different process variables such as, e.g., different viscosity ranges of the fluid stream, different contaminants in the process stream or other process variables and may be selectively loaded or installed on sensor device 110 and control station 300 as needed to handle these process variables. In other embodiments, there may be no need to have separate selectively installed modules where memory limitations on sensor device 110 or control station 300 allow for the use of omnibus modules having a full suite of functionality that may be selectively executed for the particular use to be alternatively installed on sensor device 110 and control station 150. In some embodiments, a library of software modules may be available that enables selective loading and installation of particular modules onto sensor device 110 and control station 300 for the particular use case, fluid stream, analyte, reagent or any other parameter. In some embodiments, a user of computing system 400 may be able to generate new modules, for example, if a new use case is present and there are no corresponding modules in the library. Such modules may be generated, for example, based on lab data or other data analysis and may also correspond to the generation of one or more new calibration profiles 258.

With reference to FIGS. 24-26, a calibration framework implemented by system 100 will be described according to an embodiment. The calibration framework is implemented by processing device 250 and includes the execution of computation and control module 256 to perform one or more computation algorithms, also referred to herein individually and collectively as the computational algorithm. The computational algorithm utilizes values or other information stored in calibration profiles 258. In some embodiments, some or all of the calibration framework may also or alternatively be implemented by processing device 304 and may also or alternatively include execution of pump control module 312 and computation module 316. The computational algorithm may be executed to perform particular measuring, computing, pumping or other operations. In some embodiments, the calibration framework may utilize a standardized file format.

The calibration algorithm comprises a finite state machine (FSM) executed by processing device 250 that performs a large number of math operations, such as multiplication and addition, at high speed in order to translate raw data into an accurate concentration measurement. The concentration algorithm utilizes a look-up-table (LUT) calibration curve array, e.g., as defined by calibration profiles 258, to perform LUT correction operations in sequence according to the FSM. The electronic instruments of circuitry 130 which interfaces with optical sensors 150 may produce 10-bit raw ADC values ranging from 0 to 1023 that correspond to the photodiode current. This raw value may contain sources of error as the signal relates to optical signal strength or chemical concentration. One example source of error may be temperature fluctuations acting on the photodiode. A calibration curve relating the relative photodiode efficiency to its temperature may be stored in memory 254, e.g., in a calibration profile 258. The computational algorithm compensates for the effect of temperature by looking up the appropriate correction factor based on temperature measurements.

Calibration profiles 258 enable rapid recalibration of the computational algorithm. Calibration profiles 258 may comprise binary files, text files or any other file type. In some embodiments, calibration profiles 258 may comprise CSV or JSON files. The computational algorithm may be specialized or reconfigured by modifying numerical values that are contained in calibration profiles 258.

The file naming convention and folder directory tree format of the calibration framework may correspond to hardware elements of sensor device 110, control station 300 or both. For example, a sensor device 110 may be customized by a user during assembly by selecting particular optical filters 152 or other components, e.g., based on the reagent to be used, target analyte, fluid stream composition or any other parameters. Circuitry 130 for that sensor device 110 may then be tuned by the user for those filters 152 by modifying the numerical values contained in the corresponding calibration profiles 258.

In some embodiments, sensor device 110 may be assembled with a set of pre-loaded versatile calibration profiles 258 which may be intended to be fine-tuned by users. In another embodiment, a user may load one or more calibration profiles 258 into memory 254 that correspond to the particular filter 152 that was included in the assembly.

Electronic data loaded into memory 254 may follow a standardized file naming convention and file tree format which is recognizable by processing device 250 when executing computation and control module 256 to implement the computational framework. This standardized file naming convention and file tree format allows processing device 250 to recognize and correlate autonomous operating parameters of the system 100 with the numerical values contained in the corresponding calibration profiles 258.

IO interface 252 of sensor device 110 may comprise a programming port, such as a USB connector, which is configured to connect to a computing device or system to allow a user to access and modify calibration profiles 258 while sensor device 110 is installed in-situ. In some embodiments, sensor device 110 may comprise removable memory, such as removable flash memory, which may be removed or replaced and enables calibration profiles 258 to be assessed or modified. Calibration profiles 258 may also be accessed or modified through the serial communication bus of IO interface 252 which is utilized for transmitting sensor data 260 control station 300, computing system 400 or sensor data storage 410. As an example, an IO interface 252 such as, e.g., an RS-485 MODBUS or Ethernet computer network cables may be utilized to connect sensor device 110 to network 118 or control station 300.

Calibration profiles 258 may contain single-dimensional numerical parameters, such as a floating-point decimal ratio, or multi-dimensional numerical parameters, such as 2D spectral plots. Multi-variable calibration profiles 258 may relate more than one dependent variable to a single index variable. For example, a single calibration profile 258 may contain a 3D plot relating relative radiant intensity (Y axis) and relative effect of pH on radiant intensity (Y axis) to wavelength (X axis).

Several numerical parameters may be organized within a single calibration profile 258. For example, a computing system 400 may comprise a software tool that assists users in compiling detailed information about the system configuration, e.g., based on the selected components, target analyte, operating environment, fluid stream, or any other information. The software tool may assist the user in generating a corresponding calibration profile 258, e.g., a binary-format file, that is loaded into memory 254 of sensor device 110 for that system configuration.

Calibration profiles 258 may contain values, such as, e.g., binary values, which are interpreted by processing device 250 when executing the computational algorithm of computation and control module 256 in order to activate or de-activate particular portions of the computational algorithm. For example, the computational algorithm may contain several mixing programs. Each mixing program may be digitally configurable according to one or more corresponding calibration profiles 258. For example, each mixing program may be activated, deactivated or repeated in sequences by processing device 250 according to the computation algorithms based on the values in the corresponding calibration profiles 258. By manipulating the values contained in calibration files, different mixing programs may be activated, deactivated or repeated. For example, when executing a particular computation algorithm, processing device 250 may obtain parameter values corresponding to the mixing style, duration of the mixing, length of the delay period between mixing procedures and the number of times each mixing procedure is repeated from corresponding calibration profiles 258 and implement those parameters in the computation algorithm.

Calibration profiles 258 may contain values that are organized in lookup tables representing a multi-dimensional dataset, for example a 2D or 3D plot. The continuous curve of a complex mathematical function may be represented by a set of X-Y coordinates (or X-Y-Z coordinates in a 3D plot), which are processed by processing device 250 during execution of the computational algorithm in order to closely approximate the mathematical function. For example, data points that are not in the lookup table may be computed using lincar interpolation computation. The use of such lookup tables in calibration profiles 258 enables a user to calibrate the performance of a sensor device 110 using plot data resulting from characterization measurements produced by laboratory instruments. For example, a CSV format plot of radiant intensity (Y axis) over wavelength (X axis) produced by a laboratory spectrometer may be compatible with the calibration profile 258 format and may simply be downloaded to sensor device 110 with little or no modification as a corresponding calibration profile 258. In another example, the CSV lookup table may contain a relationship between the output current of an optical sensor 150 in the presence of a constant radiant flux (Y axis) and temperature (X axis). Processing device 250 is configured to parse the lookup tables in order to generate calibration functions that are executable by the calibration algorithms of computation and control module 256.

Laboratory analytical equipment such as spectrometers or fluorometers may be used to generate complex calibration curves relating radiant intensity to concentration. Reference samples containing known quantities of analyte may be prepared in the lab and characterized using a spectrometer. Furthermore, an array of experiments can be conducted to characterize spectral intensity vs. concentration at varying temperatures, pH levels, pressures or any other attributes of the fluid stream or sensor environment. A complex system of calibration curves may be stored in flash memory of sensor device 110 and may be accessed by the FSM algorithm based on auxiliary sensor data. In some embodiments, the algorithm may activate or deactivate calibration curves based on thresholds defined by the auxiliary sensor data.

With reference now to FIG. 24, an example sampling and measurement process using the computational algorithm is described. The example process of FIG. 24 comprises steps 700 through 512 although additional or fewer steps may alternatively be implemented. The sampling and measurement process of FIG. 24 may be performed by processing device 250 executing computation and control module 256 and its corresponding computational algorithm in conjunction with calibration profiles 258 stored on sensor device 110. As mentioned above, any portion of the functionality of computation and control module 256 may also or alternatively be performed by processing device 304 of control station 300.

The sampling and measurement process is controlled by the execution of the computational algorithm by processing device 250. The computational algorithm is configured to compute accurate concentration measurements from the raw signal values obtained by the optical sensors 150. A single measurement cycle comprises several automated procedures that may be software-modulated by the computational algorithm in order to create the conditions for accurate measurement.

At step 700, the processing device 250 performs a first measurement cycle of an auto-ranging procedure of the computational algorithm at a first dilution factor. The first measurement cycle comprises a rough measurement of a fluid stream sample. The rough measurement is utilized because the reagent may have a nominal range in which the radiant intensity is most predictably relatable to concentration of the target analyte. For example, the reagent may have linear characteristics from 0 to 100 parts-per-million (ppm) but may be less accurate for values greater than 100 ppm. The first measurement cycle may use a first dilution factor to dilute the fluid stream sample by a large ratio, for example, a 9:1 dilution factor. This first dilution factor may be selected at a ratio that ensures that the concentration of the mixed fluid stream sample falls within the target range, e.g., 0 to 100 ppm. In this example, the maximum effective range of the analyte measurement for the fluid stream sample diluted at the first dilution factor would be 0 to 1000 ppm.

At step 702, processing device 250 obtains a rough measurement value based on the first measurement cycle. For example, the first measurement cycle may result in a rough measurement value of 15 parts per million of the mixture, which corresponds to a fluid stream concentration of the target analyte being approximately 150 ppm.

At step 704, processing device 250 determines a second dilution factor based on the rough measurement value, e.g., by scaling the dilution factor to a ratio that optimizes the second measurement cycle to fit within the nominal dynamic range of the reagent. In this example, processing device 250 may select a dilution factor of 1:1 for the second measurement cycle, making the effective range of the second measurement cycle 0 to 200 ppm which closely encompasses the anticipated measurement of approximately 150 ppm.

At step 706, processing device 250 performs the second measurement cycle at the second dilution factor. The second measurement cycle comprises a fine measurement of the fluid stream sample taking into account the rough determination of the concentration of the analyte being approximately 150 ppm.

At step 708, processing device 250 obtains a fine measurement value based on the second measurement cycle. For example, the second measurement cycle may result in a fine measurement value of 168 ppm of the analyte in the mixed fluid stream sample. In this manner, processing device 250 may autonomously improve signal-to-noise ratio during operation to generate improved accuracy on the concentration measurements of the target analyte while reducing potential reagent usage and waste.

The particular processing operations and other system functionality described in conjunction with the flow diagram of FIG. 24 are presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement the disclosed embodiments.

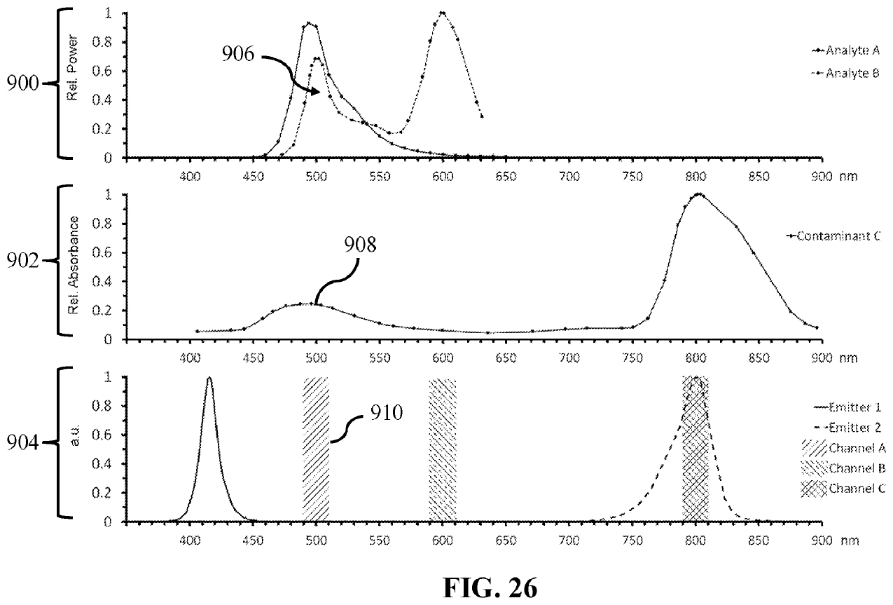

With reference to FIG. 26, graph 900 illustrates calibration curves representing analytes A and B in the presence of reagent, graph 902 illustrates a calibration curve representing contaminant C and graph 904 illustrates a graphical representation of sensor instruments, including optical sensor bandpass filter channels A, B, and C corresponding to filters 152 that are assembled with corresponding optical sensors 150 and emitters 1 and 2 corresponding to different light sources 146 where each light source 146 may comprise a different wavelength such as, e.g., ultraviolet (emitter 1) or infrared (emitter 2). For example, emitter 1 is configured to induce fluorescence of analytes A and B in the presence of reagent. Channels A and B are configured to quantify the emission peaks. Emitter 2 in combination with channel C may be configured to quantify contaminant C by measuring the difference in emitted and received light centered at 800 nm.

In some embodiments, the computational algorithm may compensate concentration measurements based on an auxiliary sensor measurement that is used in combination with a mathematical compensation function. For example, the processing device 250 executing the computational algorithm may obtain a temperature measurement during the mixing process and may access a corresponding calibration profile 258 containing a correction coefficient or a lookup table containing several coefficients corresponding to temperature ranges. In this example the coefficient relates a relationship between the current output by an optical sensor 150 and a temperature of the optical sensor 150. The processing device 250 executing the computational algorithm may perform a linear interpolation calculation on values in the lookup table in order to compute a compensation factor that is tuned for the actual measured temperature at the time of measurement. In this manner, the processing device 250 may integrally compensate the raw current measurements from optical sensors 150 in order to inhibit or negate any errors caused by temperature fluctuations during each measurement cycle or between measurement cycles.

In another example of the computation framework, a similar process may be performed by processing device 250 to inhibit or negate the effect of pH on reagent luminescence. For example, a calibration profile 258 containing a lookup table representing a 2D plot of the relationship between radiance (on the Y axis) and pH (on the X axis) for the reagent may be produced by a user of the sensor, e.g., as a result of numerical values obtained from characterization testing in a laboratory. A pH sensor may be disposed in the fluid stream in close proximity to and in fluid communication with sensor device 110 and may provide pH data at the time of measurement. In some embodiments, the pH sensor may be integrated into sensor device 110 itself, e.g., at any location coming into contact or otherwise exposed to the fluid stream sample. Processing device 250 may execute the computational algorithm to compute a relative radiance coefficient based on values in the lookup table. The measurement values may then be compensated accordingly. For example, current values output by optical sensors 150 may be compensated based on the computed coefficient in order to inhibit or negate the effects of pH variation in the fluid stream sample.

Calibration profiles 258 containing compensation parameters, for example, lookup tables, may also contain configuration parameters, for example a text file header, which allows the computational algorithm to associate the contained information with a particular sensor device 110 or more than one sensor device 110, or with a particular order of operations in the computation process. For example, a file containing a temperature compensation lookup table for a particular optical sensor 150 may contain a numerical or text string containing the hardware address of the temperature sensor, the hardware address of the optical sensor 150 and a program address which tells the computational algorithm when to apply the compensation to the measurement value. For example, the computational algorithm may be instructed to perform current compensation on the output of the optical sensor 150 prior to pH-radiance compensation by assigning the program address values of the calibration profiles 258. In this example, performing pH compensation after the temperature compensation may reduce the amplification of error, resulting in more accurate computation of the analyte concentration.

The processing device 250 executing the computational algorithm may parse calibration profiles 258 containing lookup tables in order to modify the software functions of the computation algorithm that represent an approximation of a mathematical function, complex curve or multivariable equation. For example, the lookup tables may contain index values (X axis) and compensation values (Y axis). Processing device 250 may compute the precise compensation value based on a specific index value. For example, a lookup table may contain compensation values for the index values 0, 10, 20 and 30. In this example, processing device 250 may compute an interpolated value for the index value of 25. Processing device 250 may test each entry of the lookup table in sequence, e.g., using logical operators, to determine the bounds for linear interpolation. In this example, processing device 250 may determine that the input value is between 20 and 30 and may linearly interpolate a compensation value for 25, e.g., using the slope-intercept form equation “y =mx +b”. Users of system 100 may generate calibration profiles 258 containing many lookup table entries, for example, using computing system 400 or laboratory instruments. These lookup tables allow for close approximation of complex mathematical functions by processing device 250 while greatly reducing the need for on-board computational power of the computing device 110. Processing device 250 may scan calibration profiles 258 to search for a linear segment of a complex curve to be used in a computation, e.g., based on input parameters of that computation.

Calibration profiles 258 may be interpreted by the processing device 250 executing the computational algorithm to generate a digital representation of integral equations that may be processed by sensor device 110 using simple mathematical operators such as addition and multiplication. For example, the area of a portion of a spectral curve that is represented by a lookup table may be computed by determining Y-axis linear segments as described above, calculating the area of trapezoidal segments under the curve and then adding the area of those segments to closely approximate the integral of any specific portion of a curve represented by lookup tables.

The processing device 250 executing the computational algorithm may compute overlap ratio coefficients of overlapping integral curve segments. For example, the ratio of overlapping of emission spectra contained in calibration files and bandpass transmittance regions may be computed by processing device 250. The transmittance region of a bandpass filter may be considered by the algorithm to be significantly rectangular, with the transmittance coefficient being the Y-axis dimension and wavelength being the X-axis dimension. Alternatively, non-rectangular bandpass curves may be represented by calibration profiles 258. A ratio may be computed as part of the measurement computation process, relating a specific portion of a spectral curve integral, with the transmittance integral of the corresponding bandpass filter. This ratio may serve as an inverse correction factor relating the measured radiant intensity of that optical sensor channel to chemical concentration, or serve as a variable that is inputted to a subsequent computation function which computes chemical concentration.

In some embodiments, system 100 may be configured to quantify more than one activated analyte, or be configured to quantify contaminants affecting the mixture characteristics, in order to systematically resolve the concentration of the targeted analytes. For example, system 100 may be configured to quantify two analytes in a fluid stream sample that are being sensitized by a single reagent in the presence of a single contaminant. The emission peaks of each analyte may overlap with one another, e.g., as referenced by 906, or may overlap with the absorption peaks of contaminants, e.g., as referenced by 908. The processing device 250 executing the computational algorithm may be configured to compute the concentration of each component in a specific sequence, e.g., beginning with signals that are independent, and using parameters from those measurements to compensate the dependent measurements.

The processing device 250 executing the computational algorithm may be configured to simulate complete spectra by multiplying values of a lookup table by a coefficient that is computed based on measured parameters. For example, a radiance spectrum of activated analytes A and B may be contained in a lookup table of a corresponding calibration profile 258 from a range of 450 nm to 650 nm, e.g., as shown in graph 900. Y-axis units may be in terms of relative radiant intensity or ADC counts. Processing device 250 may produce a simulated spectrum representing the present activated mixture by multiplying Y-axis values of the calibration curve by a computed coefficient. In this manner, processing device 250 is configured to simulate the radiance of Analyte B in spectral regions where physical measurements are not available to the computational algorithm or in spectral regions where mixed signals exist and must be individually resolved, e.g., as shown in graph 906.

System 100 may be configured to measure the concentration of two or more analytes, where at least one spectral peak of one analyte overlaps with the spectrum of another analyte. In this example 900, activated analyte B produces two distinct spectral peaks centered on 500 nm and 600 nm respectively. Analyte A produces one spectral peak centered on 500 nm. Sensor device 110 may contain two bandpass detector channels, one each centered on 500 nm and 600 nm respectively. The computing device 250 executing the computation algorithm may first quantify the signal at 600 nm, independently representing the concentration of activated analyte B. Computing device 250 may utilize the measurement obtained from the 600 nm bandpass channel to compute a multiplier value. The values contained in a lookup table representing the spectrum of analyte B may then be scaled by the multiplier value in order to compute a simulated radiant contribution of analyte B at the 500 nm bandpass region, e.g., as referenced by 910. The simulated contribution may be subtracted from the measured total at the 500 nm bandpass region in order to obtain a value representing the radiant intensity of analyte A.

System 100 may be configured to spectrally resolve the interference factor of contaminants that are not analytes in order to resolve the concentration of analytes. In the example mentioned above, analytes A & B may be accompanied by contaminant C. The contaminant molecule, for example a hydrocarbon, may have an absorbance spectrum, e.g., as shown in graph 902, which overlaps with the emission peaks of A and B. Sensor systems may contain a light source 146 having an emission spectrum that overlaps with bandpass spectra centered on absorption peaks of the contaminant C, in order to quantify contaminant C using the previously described methods. The computing device 250 executing the computation algorithm may utilize a calibration profile 258 representing the relative absorbance of C across the spectrum, in order to simulate an absorbance coefficient for each of the affected bandpass channels. In this manner, measurements of the analytes may be compensated dynamically by quantifying the absorption of the contaminants.

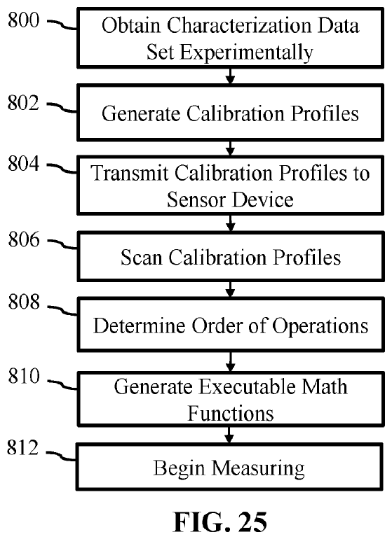

With reference now to FIG. 25, an example calibration process using the above-described calibration framework will be described according to an embodiment. The example process of FIG. 25 comprises steps 800 through 812 although additional or fewer steps may alternatively be implemented. The calibration process of FIG. 25 may be performed at least in part by one or more of sensor device 110, control station 300 and computing system 400.

At step 800, processing device 402 obtains a characterization data set that is generated experimentally, e.g., based on sensor data obtained from a sensor device 110, in a laboratory setting or from another source.

At step 802, processing device 402 generates one or more calibration profiles 258, e.g., based on user input via a user interface or software tool.

At step 804, processing device 402 transmits the generated calibration profiles 258 to control station 300, sensor device 110 or both.

At step 806, processing device 250 executes the computational algorithm and scans the calibration profiles 258, e.g., as described above.

At step 808, processing device 250 determines an order of operations for any corrections to the measurement, e.g., as described above. For example, processing device 250 may determine that temperature corrections are performed before pH corrections.

At step 810, processing device 250 generates executable math functions based on the calibration profiles 258 and the determined order of operations.

At step 812, processing device 250 initiates a measurement cycle based on the generated executable math functions.

The particular processing operations and other system functionality described in conjunction with the flow diagram of FIG. 25 are presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement the disclosed embodiments.

FIGS. 1 through 26 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

It should be understood that the various aspects of the embodiments could be implemented in hardware, firmware, software, or combinations thereof. In such embodiments, the various components and/or steps would be implemented in hardware, firmware, and/or software to perform the functions of the disclosed embodiments. That is, the same piece or different pieces of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A fluid concentration measurement system comprising:
a sensor device comprising:
a sampling and measurement unit that is configured for insertion into a fluid stream, the sampling and measurement unit being configured to obtain a fluid sample from the fluid stream and to mix a reagent with the fluid sample to form a mixed sample;
a light source that is configured to illuminate the mixed sample; and
an optical sensor that is configured to:
receive light from the mixed sample based at least in part on the illumination of the mixed sample; and
generate sensor data based on the received light; and
at least one processor that is configured to:
obtain the sensor data; and
determine a concentration of a target analyte in the fluid stream based on the sensor data.

2. The system of claim 1, wherein the sampling and measurement unit comprises a chamber, the chamber being in fluid communication with the fluid stream via a sample flow channel when the sampling and measurement unit is inserted into the fluid stream to obtain the fluid sample.

3. The system of claim 2 wherein the chamber is in fluid communication with a reagent flow channel, the sampling and measurement unit being configured to dispense the reagent from the reagent flow channel into the chamber for mixing with the fluid sample.

4. The system of claim 3 wherein the chamber is in fluid communication with a fluid flow channel, the sampling and measurement unit being configured to dispense a purge fluid from the fluid flow channel into the chamber.

5. The system of claim 4 wherein the sampling and measurement unit is configured to obtain the fluid sample from the fluid stream by causing a reverse flow of the purge fluid in the fluid flow channel to draw to the fluid sample from the sample flow channel into the chamber.

6. The system of claim 4 wherein the sampling and measurement unit is configured to oscillate between a forward flow and a reverse flow of the purge fluid in the fluid flow channel to facilitate a mixing of the fluid sample with the reagent in the chamber.

7. The system of claim 4 wherein the sampling and measurement unit is configured to purge the mixed sample from the chamber into the sample flow channel by causing a forward flow of the purge fluid in the fluid flow channel.

8. The system of claim 7 wherein the light source is configured to illuminate the mixed sample as it is purged into the sample flow channel and the optical sensor is configured to receive light from the mixed sample in conjunction with the purging.

9. The system of claim 4 further comprising a control station, the control station comprising at least one metering pump in fluid communication with at least one of the reagent flow channel and the fluid flow channel, the at least one metering pump being configured to cause forward and reverse flows in the reagent flow channel and fluid flow channel.

10. The system of claim 1 wherein the sensor device is configured to generate the sensor data in real-time while the sampling and measurement unit is inserted into the fluid stream.

11. The system of claim 1 wherein the at least one processor is configured to determine a value of at least one attribute of the fluid stream, correct the sensor data for the determined value of the at least one attribute of the fluid stream and determine the concentration of the target analyte based on the corrected sensor data.

12. The system of claim 11 wherein the at least one processor being configured to correct the sensor data for the determined value of the at least one attribute of the fluid stream comprises the at least one processor being configured to:
access a look-up-table corresponding to the at least one attribute of the fluid stream; and
correct the sensor data based at least in part on:
the look-up-table;
the determined value of the at least one attribute of the fluid stream; and
the sensor data.

13. The system of claim 11 wherein the at least one processor is configured to:
obtain an updated look-up-table corresponding to the at least one attribute; and
replace the look-up-table with the updated look-up-table.

14. The system of claim 1 wherein the sensor device comprises a filter, the filter being selected based at least in part on the target analyte and being disposed between the optical sensor and the mixed sample to filter the light received by the optical sensor from the mixed sample to a predetermined wavelength band.

15. The system of claim 1 wherein the target analyte comprises a metal ion and the reagent comprises at least one of a metal-organic-framework (MOF)-based reagent and a carbon nanomaterial-based reagent.
